(19) United States
(12) Patent Application Publication
(10) Pub. No.: US 2018/0164635 A1
(43) Pub. Date: Jun. 14, 2018

(54) SHEET MEMBER BONDING APPARATUS AND SHEET MEMBER BONDING METHOD

(71) Applicant: SHARP KABUSHIKI KAISHA, Sakai City, Osaka (JP)

(72) Inventor: KATSUHIRO YAMAGUCHI, Sakai City (JP)

(21) Appl. No.: 15/580,388

(22) PCT Filed: Jun. 3, 2016
(86) PCT No.: PCT/JP2016/066577

§ 371 Date: Dec. 7, 2017

(30) Foreign Application Priority Data
Jun. 12, 2015 (JP) 2015-119219

(51) Int. Cl. G02F 1/1335; G02B 27/28; G02F 1/13; G02B 5/30

(52) U.S. Cl. CPC G02F 1/133528; G02F 1/133514; G02B 5/3033; G02F 1/1303; G02B 27/28

(57) ABSTRACT

The polarizing plate bonding apparatus 20 includes a panel support stage 21 that supports a liquid crystal panel 11, a polarizing plate support stage 22 that supports a polarizing plate 12 having at least a pair of sides 12LS and 12SS and a corner 12C formed by the pair sides 12LS and 12SS such as to face a bonding surface 11a1 of the liquid crystal panel 11, a pressure roller 23 that is rotatable and presses the polarizing plate 12 against the liquid crystal panel 11, the pressure roller 23 having a rotation axis 23AX inclined to each of the pair of sides 12LS and 12SS of the polarizing plate 12, and a moving mechanism for moving the panel support stage 21, and the polarizing plate support stage 22 and the pressure roller 23, relative to each other along the bonding surface 11a1.

### TECHNICAL FIELD

The present invention relates to a sheet member bonding apparatus and a sheet member bonding method.

### BACKGROUND ART

Liquid crystal panels, which are one type of display panel, include polarizing plates for display, and such polarizing plates are bonded by means of a polarizing plate bonding apparatus in a production process. As one example of such a polarizing plate bonding apparatus, one that is described in Patent Document 1 is known. This polarizing plate bonding apparatus includes a stage, a polarizing plate suction stage, and a bonding roller. The stage retains, on its upper face, a display panel having a main surface on the upper side to which a polarizing plate is to be bonded, and moves in a horizontal direction. The polarizing plate suction stage is arranged above the stage and holds by suction, on its lower face, the polarizing plate to be bonded to the display panel such that part of the polarizing plate extends out in the moving direction of the stage. The bonding roller is arranged on a forward side of an end portion of the polarizing plate suction stage at which the polarizing plate is extended, and presses the polarizing plate with a certain pressure as the stage moves to bond the polarizing plate onto the upper side main surface of the display panel secured on the upper face of the stage. The bonding roller includes a heating means for applying heat to the polarizing plate.

### RELATED ART DOCUMENT

### Patent Document

Patent Document 1: Japanese Unexamined Patent Application Publication No. 2013-174799

### Problem to be Solved by the Invention

In Patent Document 1 noted above, the polarizing plate is heated by the heating means to soften an adhesive material so as to improve adhesiveness between the polarizing plate and the display panel, and to push out air bubbles. While the effect of suppressing formation of air bubbles is achieved to some extent in Patent Document 1, the effect is not necessarily sufficient, and it was difficult to prevent formation of air bubbles to a satisfactory level.

### DISCLOSURE OF THE PRESENT INVENTION

The technology disclosed herein was made in view of the above circumstance. An object is to sufficiently suppress formation of air bubbles.

### Means for Solving the Problem

A sheet member bonding apparatus of the present invention includes a panel support unit that supports a display panel, a sheet support unit that supports a sheet member having at least a pair of sides and a corner formed by the pair of sides such as to face a bonding surface of the display panel, a pressure roller that is rotatable and presses the sheet member against the display panel, the pressure roller having a rotation axis inclined to each of the pair of sides of the sheet member, and a moving mechanism that relatively moves the panel support unit, the sheet support unit, and the pressure roller along the bonding surface.

With the sheet member bonding apparatus configured as described above, to bond a sheet member to a display panel, first, the sheet member supported by the sheet support unit is positioned opposite the bonding surface of the display panel supported by the panel support unit. The sheet member is pressed against the display panel with the pressure roller in this state, and as the panel support unit, and the sheet support unit and pressure roller, are moved relative to each other by the moving mechanism along the bonding surface, the pressure roller is rotated, so that the bonding of the sheet member to the display panel progresses. Since the rotation axis of the pressure roller is inclined to each of the pair of sides of the sheet member, the pressure roller contacts the corner formed by the pair of sides of the sheet member at the start and end of bonding of the sheet member to the display panel. The contact area at this time is at least shorter than any of the lengths of the sides of the sheet member. As the contact area of the pressure roller with the sheet member is made sufficiently small in this way, air is hardly entrapped between the sheet member and the display panel. Thus, air is hardly entrapped between the sheet member and the display panel at the start and end of bonding of the sheet member to the display panel when the possibility of air entrapment is particularly high, and accordingly air bubble formation is favorably suppressed.

The following configurations are preferable as embodiments of the sheet member bonding apparatus according to the present invention.

(1) The pressure roller may be arranged such that the rotation axis is inclined to each of the pair of sides of the sheet member in a range from 2° to 88°. In this way, the contact area of the pressure roller with the corner of the sheet member is made sufficiently short at the start and end of bonding of the sheet member to the display panel, so that air bubble formation is suppressed more favorably.

(2) The sheet member may have a quadrate shape having the pair of sides and the corner may include a pair of corners that are not diagonal to each other, and the rotation axis of the pressure roller may be inclined to each of the pair of sides such that the pair of corners that are positioned front and back in a direction of movement of the moving mechanism are offset in the direction of movement and a distance therebetween is equal to or smaller than a width of the pressure roller. In this way, when the bonding of the sheet member to the display panel is started, the pair of corners of the quadrate sheet member, which are positioned front and back relative to the moving direction by the moving mechanism and which are not diagonal to each other, are pressed by the pressure roller at the same timing. In this way, air is hardly entrapped between part of the sheet member, particularly between the pair of corners noted above, and the display panel, so that air bubble formation is suppressed favorably.

(3) The sheet support unit may include a pair of sides parallel to the pair of sides of the sheet member, respectively. In this way, the sheet member is positioned highly accurately by being supported by the sheet support unit such that the pair of sides of the sheet member are parallel to the pair of sides of the sheet support unit. In this way, misalignment of the sheet member relative to the display panel hardly occurs.

(4) The panel support unit includes a pair of sides parallel to a pair of sides of the display panel. In this way, the display panel is positioned highly accurately by being supported by the panel support unit such that the pair of sides of the display panel are parallel to the pair of sides of the panel support unit. In this way, misalignment of the display panel relative to the sheet member hardly occurs.

(5) The load applied by the pressure roller on the sheet member may be made smaller at the start and end of bonding of the sheet member to the display panel than during the bonding. The contact area of the pressure roller with the sheet member is smaller at the start and end of bonding of the sheet member to the display panel than middle of the bonding. Thus, the load applied from the pressure roller to the sheet member is made smaller at the start and end of bonding than during the bonding, so that the load, i.e., pressure, per unit area applied from the pressure roller to the sheet member is made uniform between the start and end of bonding and during the bonding. In this way, the pressure applied from the pressure roller to the sheet member varies little during the bonding process, so that air is hardly entrapped between the sheet member and the display panel during the bonding process, and accordingly air bubble formation is favorably suppressed.

(6) The pressure roller may be arranged away from the corner of the sheet member frontward of a direction of movement of the panel support unit relative to the sheet support unit and the pressure roller by the moving mechanism when starting bonding of the sheet member to the display panel. In this way, when the bonding of the sheet member to the display panel is started, the pressure roller is not in contact with the corner of the sheet member. After the bonding has been started, the pressure roller is brought into contact with the corner of the sheet member from the front side of the moving direction of the panel support unit relative to the sheet support unit and pressure roller moved by the moving mechanism. The sheet member is therefore pressed gradually by the pressure roller from the tip of the corner, so that air is more hardly entrapped between the sheet member and the display panel at the start of bonding, and accordingly air bubble formation is favorably suppressed.

(7) The pressure roller may be provided with an elastic material at least on a surface thereof. In this way, the pressure roller makes tighter contact with the sheet member, so that air is more hardly entrapped between the sheet member and the display panel at the start and end of bonding of the sheet member to the display panel, and accordingly air bubble formation is more favorably suppressed.

To achieve the object noted above, a sheet member bonding method according to the present invention includes positioning a sheet member that has at least a pair of sides and a corner formed by the pair of sides and is supported by a sheet support unit opposite a bonding surface of a display panel supported by a panel support unit, pressing the sheet member against the display panel with a pressure roller, and moving relatively the panel support unit, the sheet support unit, and the pressure roller with a moving mechanism along the bonding surface while rotating the pressure roller whose rotation axis is inclined to each of the pair of sides of the sheet member.

With this sheet member bonding method, first, the sheet member supported by the sheet support unit is positioned opposite the bonding surface of the display panel supported by the panel support unit. The sheet member is pressed against the display panel with the pressure roller in this state, and as the panel support unit, and the sheet support unit and pressure roller, are moved relative to each other by the moving mechanism along the bonding surface in this state, the pressure roller is rotated, so that the bonding of the sheet member to the display panel progresses. Since the rotation axis of the pressure roller is inclined to each of the pair of sides of the sheet member, the pressure roller contacts the corner formed by the pair of sides of the sheet member at the start and end of bonding of the sheet member to the display panel. The contact area at this time is at least shorter than any of the lengths of the sides of the sheet member. As the contact area of the pressure roller with the sheet member is made sufficiently small in this way, air is hardly entrapped between the sheet member and the display panel. Thus, air is hardly entrapped between the sheet member and the display panel at the start and end of bonding of the sheet member to the display panel when the possibility of air entrapment is particularly high, and accordingly air bubble formation is favorably suppressed.

### Advantageous Effect of the Invention

According to the present invention, formation of air bubbles can be sufficiently suppressed.

### BRIEF DESCRIPTION OF THE DRAWINGS

FIG. 1 is a schematic cross-sectional view illustrating a cross-sectional configuration of a liquid crystal panel according to Embodiment 1 of the present invention.

FIG. 2 is an enlarged plan view illustrating a plan configuration in a display region of an array substrate that constitutes the liquid crystal panel.

FIG. 3 is an enlarged plan view illustrating a plan configuration in a display region of a CF substrate that constitutes the liquid crystal panel.

FIG. 4 is a cross-sectional view of a polarizing plate bonding apparatus in which a polarizing plate support stage assumes its initial position.

FIG. 5 is a plan view illustrating a panel support stage that constitutes the polarizing plate bonding apparatus, and a liquid crystal panel supported thereon.

FIG. 6 is a plan view illustrating a polarizing plate support stage that constitutes the polarizing plate bonding apparatus, a polarizing plate supported thereon, and a pressure roller.

FIG. 7 is a bottom view illustrating the polarizing plate support stage that constitutes the polarizing plate bonding apparatus, the polarizing plate supported thereon, and the pressure roller.

FIG. 8 is a cross-sectional view of the polarizing plate bonding apparatus in a state in which bonding of a polarizing plate has started, with the polarizing plate support stage assuming its bonding position.

FIG. 9 is a plan view of the polarizing plate bonding apparatus in a state in which bonding of a polarizing plate has started.

FIG. 10 is a cross-sectional view of the polarizing plate bonding apparatus illustrating a state in which the pressure roller has been rotated from the start of bonding of the polarizing plate.

FIG. 11 is a cross-sectional view of the polarizing plate bonding apparatus illustrating a state in which a polarizing plate is being bonded.

FIG. 12 is a plan view of the polarizing plate bonding apparatus illustrating a state in which the polarizing plate is being bonded.

FIG. 13 is a cross-sectional view of the polarizing plate bonding apparatus illustrating a state in which the bonding of the polarizing plate has ended.

FIG. 14 is a plan view of the polarizing plate bonding apparatus illustrating a state in which the bonding of the polarizing plate has ended.

FIG. 15 is a plan view of a polarizing plate bonding apparatus according to Embodiment 2 of the present invention in a state in which bonding of a polarizing plate has started.

FIG. 16 is a cross-sectional view of a polarizing plate bonding apparatus according to Embodiment 3 of the present invention in a state in which bonding of a polarizing plate has started.

FIG. 17 is a cross-sectional view of a polarizing plate bonding apparatus according to Embodiment 4 of the present invention in a state in which bonding of a polarizing plate has started.

FIG. 18 is a cross-sectional view of a polarizing plate bonding apparatus according to Embodiment 5 of the present invention in a state in which bonding of a polarizing plate has started.

FIG. 19 is a graph showing the relationship between the load applied from the pressure roller to the polarizing plate and the position of the pressure roller in its moving direction according to Embodiment 6 of the present invention.

FIG. 20 is a graph showing the relationship between the contact area of the pressure roller with the polarizing plate and the position of the pressure roller in its moving direction.

FIG. 21 is a graph showing the relationship between the pressure applied from the pressure roller to the polarizing plate and the position of the pressure roller in its moving direction.

FIG. 22 is a graph showing the relationship between the load applied from the pressure roller to the polarizing plate and the position of the pressure roller in its moving direction according to Embodiment 7 of the present invention.

FIG. 23 is a graph showing the relationship between the pressure applied from the pressure roller to the polarizing plate and the position of the pressure roller in its moving direction.

FIG. 24 is a cross-sectional view of a polarizing plate bonding apparatus according to Embodiment 8 of the present invention in a state in which bonding of a polarizing plate has started.

### MODES FOR CARRYING OUT THE INVENTION

### Embodiment 1

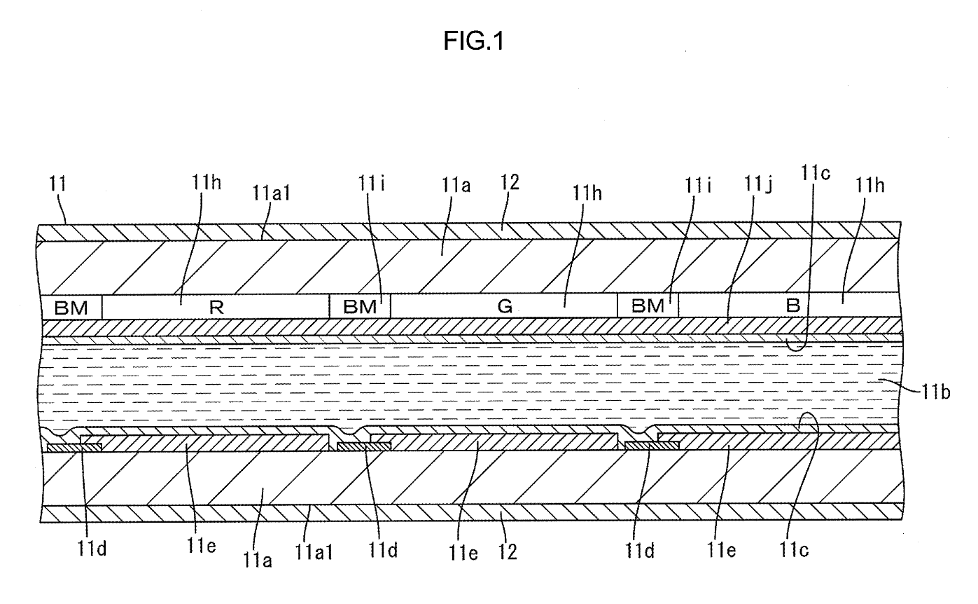

Embodiment 1 of the present invention will be described with reference to FIG. 1 to FIG. 14. This embodiment illustrates a polarizing plate bonding apparatus (sheet member bonding apparatus) 20 for bonding a polarizing plate (sheet member) 12 to a liquid crystal panel (display panel) 11 to be used in a liquid crystal display apparatus (display apparatus), and a polarizing plate bonding method (sheet member bonding method) with using the polarizing plate bonding apparatus 20. Some of the drawings show X-axis, Y-axis, and Z-axis, which are each drawn to represent respective directions indicated in respective drawings.

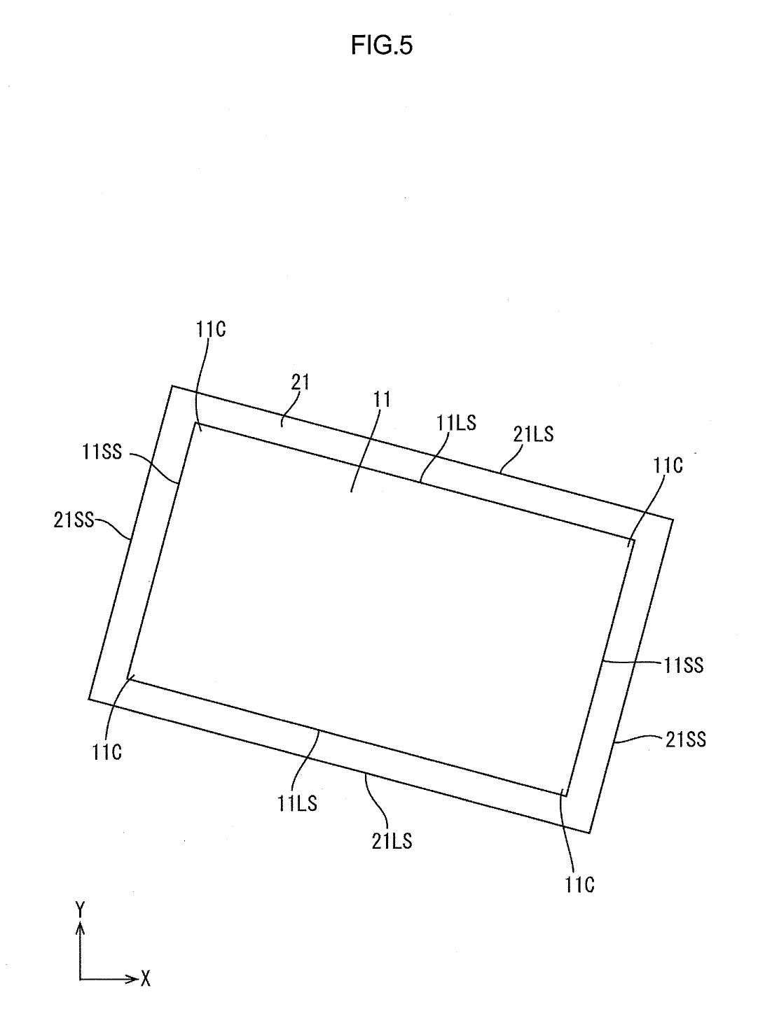

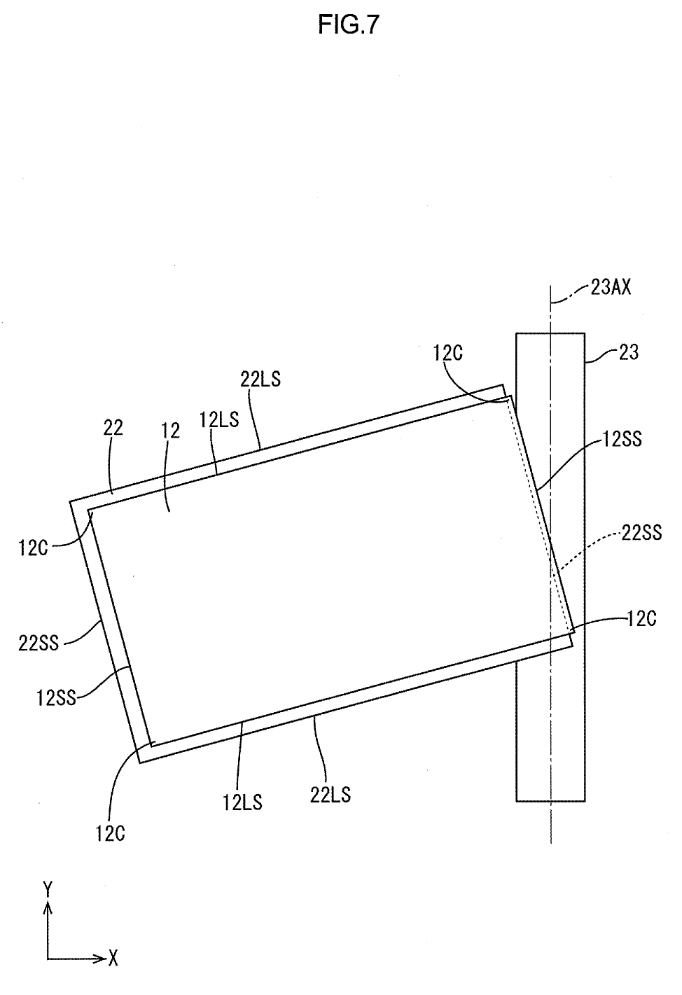

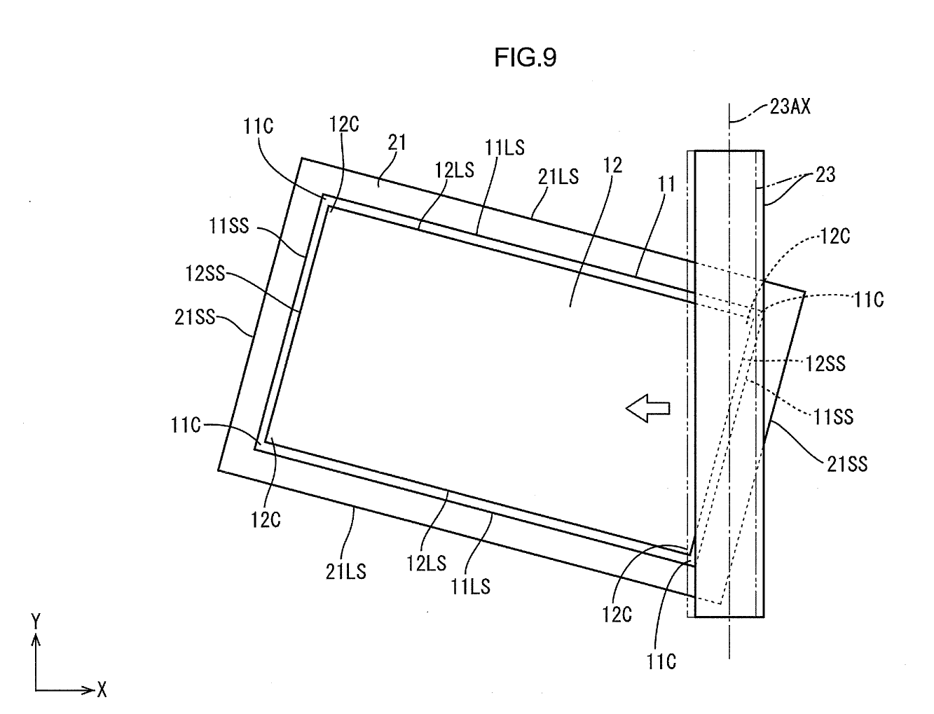

The structure of the liquid crystal panel (display panel) 11 will be described first. The liquid crystal panel 11 includes, as shown in FIG. 1, a pair of transparent (highly light transmissive) substrates 11a, and a liquid crystal layer 11b interposed between the substrates 11a and containing liquid crystal molecules, which are a substance whose optical characteristics change when an electric field is applied. The substrates 11a are bonded together with a sealant (not shown), with a cell gap defined by the thickness of the liquid crystal layer 11b being maintained. The liquid crystal panel 11 is a Twisted Nematic (TN) type or a Vertical Alignment (VA) type, for example. The pair of substrates 11a each include a substantially transparent glass substrate. A plurality of films are deposited on each glass substrate by known photolithographic techniques and the like. One of the pair of substrates 11a that is arranged on the front surface side (a front side, or an upper side shown in FIG. 1) is a CF substrate (a display substrate, a counter substrate), while the one disposed on the back side (a rear side, or a lower side shown in FIG. 1) is an array substrate (a display substrate, an element substrate, an active matrix substrate). A pair of polarizing plates (sheet members) 12 are bonded on the pair of substrates 11a, each on the outer surface on the opposite side to the liquid crystal layer 11b side (inner surface side). Each outer surface of the pair of substrates 11a is therefore a bonding surface 11a1 to which the polarizing plate 12 is bonded. The pair of polarizing plates 12 each have a surface, or bonded surface 12a, to be bonded to the bonding surface 11a1 of each substrate 11a, where a bonding layer made of an adhesive or the like is formed. The liquid crystal panel 11 has a horizontally long quadrate shape when viewed in plan, with a pair of parallel long sides 11LS, a pair of parallel short sides 11SS, and four corners 11C each made by a long side 11LS and a short side 11SS adjacent to each other in a peripheral direction (see FIG. 5). Similarly to the liquid crystal panel 11, each polarizing plate 12 has a horizontally long quadrate shape when viewed in plan, with a pair of parallel long sides 12LS, a pair of parallel short sides 12SS, and four corners 12C each made by a long side 12LS and a short side 12SS adjacent to each other in the peripheral direction (see FIG. 7). Each polarizing plate 12 has an outer shape similar to that of the liquid crystal panel 11 with smaller outer dimensions than the liquid crystal panel 11 (see FIG. 9). An alignment film 11c is formed on each of the inner surfaces of both substrates 11a in order to align the liquid crystal molecules contained in the liquid crystal layer 11b.

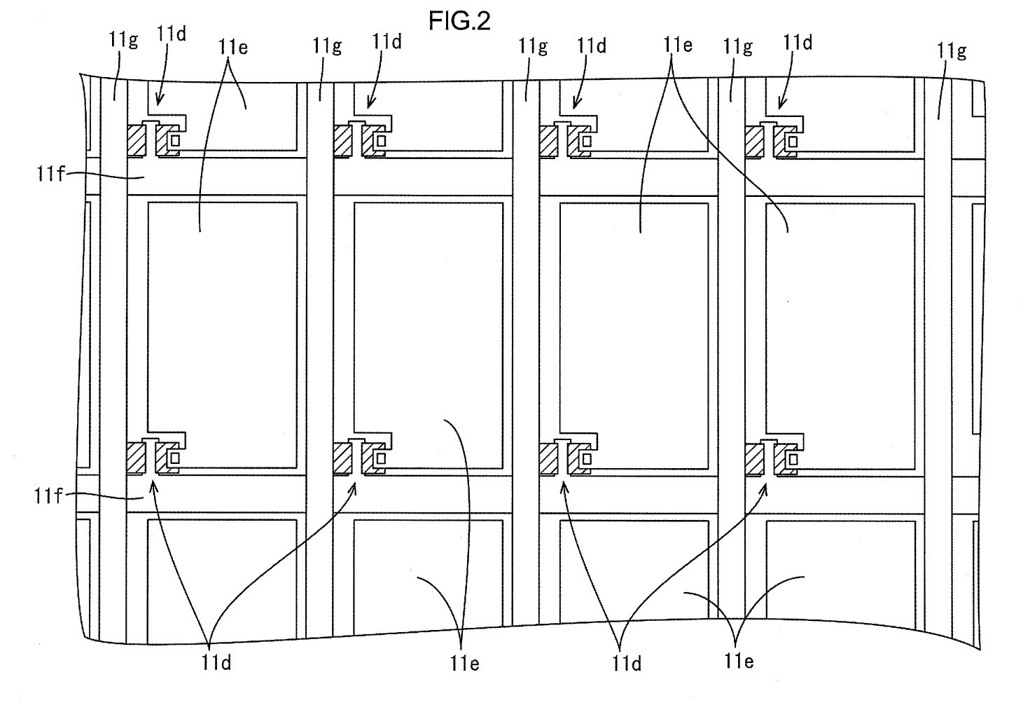

A large number of TFTs (Thin Film Transistors) 11d, which are switching elements, and pixel electrodes 11e are arranged in a matrix as shown in FIG. 1 and FIG. 2 on the inner side (liquid crystal layer 11b side) of the front side substrate 11a (array substrate) in a display region in the center of the screen where images are displayed. Gate lines 11f and source lines 11g are disposed in grids such as to surround the TFTs 11d and the pixel electrodes 11e. In other words, the TFTs 11d and the pixel electrodes 11e are arranged in rows and columns at the intersections of the grid of gate lines 11f and source lines 11g. The gate lines 11f and source lines 11g are respectively connected to the gate electrodes and source electrodes of the TFTs 11d, and the pixel electrodes 11e are connected to the drain electrodes of the TFTs 11d. The pixel electrodes 11e have a vertically long quadrate (rectangular) shape when viewed in plan, and made of a transmissive conductive film of a material that has excellent transmissivity and conductivity such as ITO (Indium Tin Oxide) or ZnO (Zinc Oxide). Capacity lines (not shown) may also be provided to the front side substrate 11a such as to be parallel to the gate lines 11f and to cross the pixel electrodes 11e.

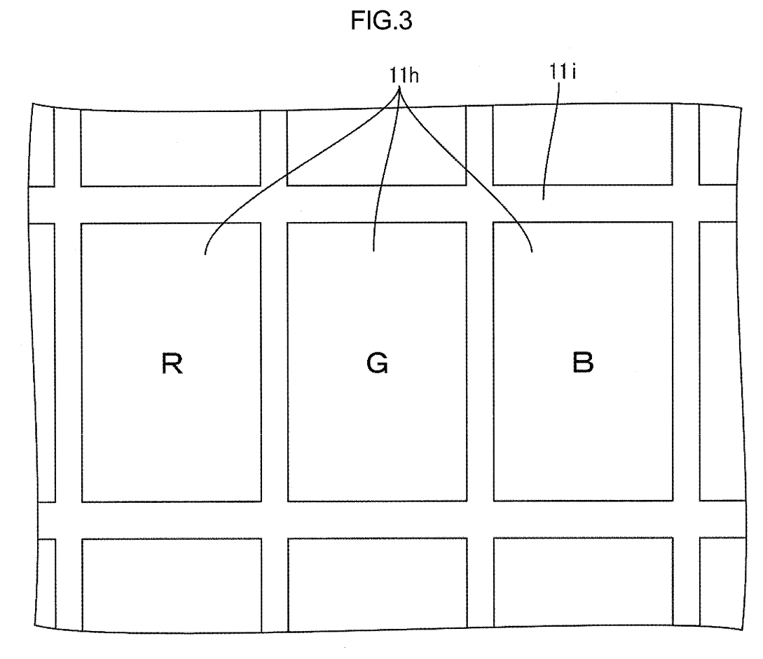

The backside substrate 11a (CF substrate) is provided with a color filter 11h on the inner surface side in the display region in the center of the screen where images are displayed. As shown in FIG. 1 and FIG. 3, a large number of color units corresponding to each of the colors R (red), G (green), and B (blue) are arranged in a matrix to overlap the respective pixel electrodes 11e of the front side substrate 11a when viewed in plan. A substantially grid-like light shielding layer (black matrix) 11i is formed to prevent color mixing between adjacent color units of the color filter 11h. The light shielding layer 11i is arranged such as to overlap the gate lines 11f and source lines 11g mentioned above when viewed in plan. A solid counter electrode (common electrode) 11j is provided on the surface of the color filter 11h and light shielding layer 11i to face the pixel electrodes 11e of the front side substrate 11a. In this liquid crystal panel 11, as shown in FIG. 1 to FIG. 3, one set of the three color units of R (red), G (green), and B (blue) and three pixel electrodes 11e opposite these units constitutes one display pixel, which is one display unit. One display pixel is made up of a red pixel having the R color unit, a green pixel having the G color unit, and a blue pixel having the B color unit. These color pixels are aligned repeatedly in rows on the plate surface of the liquid crystal panel 11 to form pixel groups, and a large number of these pixel groups are arranged in columns.

The liquid crystal panel 11 configured as described above displays images by utilizing light supplied by a backlight device, which is an external light source (not shown). More specifically, the light rays supplied by the backlight device are aligned to a certain polarizing direction as the light rays pass through the polarizing plate 12 on the backside of the liquid crystal panel 11. The polarized state of the light rays aligned to the polarizing direction is changed in accordance with the orientation of the liquid crystal molecules in the liquid crystal layer 11b. Since the orientation of the liquid crystal molecules contained in the liquid crystal layer 11b is controlled based on a potential difference between the pixel electrodes 11e and the counter electrodes 11j, the polarized state of transmitted light is controlled per each pixel electrode 11e (per each display pixel). The light rays transmitted through the liquid crystal layer 11b pass through the color filter 11h to be provided with the color corresponding to the color unit and exit the front side polarizing plate 12. The amount of light emitted from the liquid crystal panel 11 is controlled individually for each display pixel, which makes it possible to display a predetermined color image.

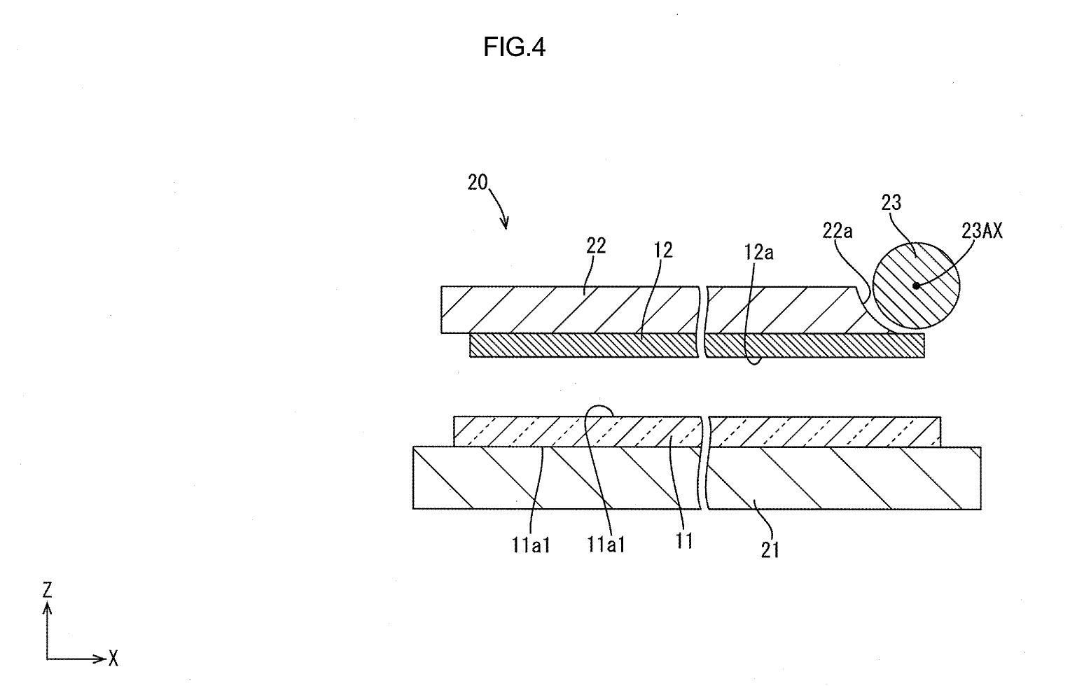

Next, the polarizing plate bonding apparatus (sheet member bonding apparatus) 20 used for bonding the polarizing plate 12 to the liquid crystal panel 11 will be described. The polarizing plate bonding apparatus 20 includes, as shown in FIG. 4, a panel support stage (panel support unit) 21 that supports the liquid crystal panel 11, a polarizing plate support stage (sheet support unit) 22 that supports the polarizing plate 12 in a position opposite the bonding surface (outer surface) 11a1 of the liquid crystal panel 11, a pressure roller 23 that is rotatable and presses the polarizing plate 12 against the liquid crystal panel 11, and a moving mechanism (not shown) for relatively moving the panel support stage 21, and the polarizing plate support stage 22 and the pressure roller 23 along the bonding surface 11a1.

As shown in FIG. 4 and FIG. 5, the panel support stage 21 supports the liquid crystal panel 11 from a lower side (a rear side) with respect to a vertical direction (the Z-axis direction in FIG. 4) such that a bonding surface 11a1 thereof is parallel to a horizontal direction. To be more specific, the panel support stage 21 supports the liquid crystal panel 11 such that one bonding surface 11a1 thereof faces upward in the vertical direction and the other bonding surface 11a1 thereof faces downward in the vertical direction. The panel support stage 21 includes a vacuum suction mechanism (not shown) that holds the other bonding surface 11a1 of the liquid crystal panel 11 by vacuum suction. The vacuum suction mechanism achieves holding of the liquid crystal panel 11. This panel support stage 21 does not move relative to the polarizing plate support stage 22 and the pressure roller 23 in directions along the horizontal direction (directions of X-axis and Y-axis shown in FIG. 5). Namely, the panel support stage 21 can be called a stationary “fixed stage”. The panel support stage 21 includes positioning pins (not shown) for the positioning of the liquid crystal panel 11 in directions along the bonding surface 11a1.

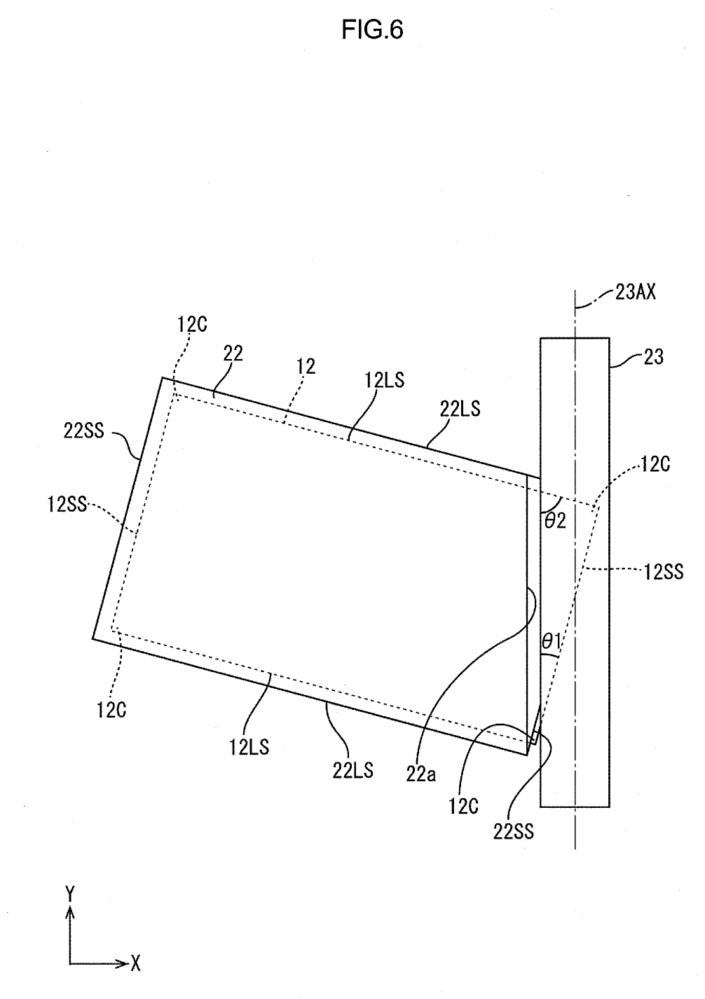

The polarizing plate support stage 22 supports the polarizing plate 12 from above (a front side) in the vertical direction, i.e., from the opposite side to the panel support stage 21 side (liquid crystal panel 11 side), as shown in FIG. 4, FIG. 6, and FIG. 7. To be more specific, the polarizing plate support stage 22 supports the polarizing plate 12 such that one plate surface thereof faces upward in the vertical direction and the other plate surface thereof faces downward in the vertical direction, i.e., toward the panel support stage 21 side (liquid crystal panel 11 side). The panel support stage 21 includes a vacuum suction mechanism (not shown) that holds the one plate surface of the polarizing plate 12 (plate surface opposite to the panel support stage 21 side) by vacuum suction. The vacuum suction mechanism achieves holding of the polarizing plate 12. When the polarizing plate 12 is held with the polarizing plate support stage 22, the other plate surface that is not held by the vacuum suction mechanism by vacuum suction faces the bonding surface 11a1 of the liquid crystal panel 11, and this plate surface is the bonded surface 12a to be bonded to the liquid crystal panel 11.

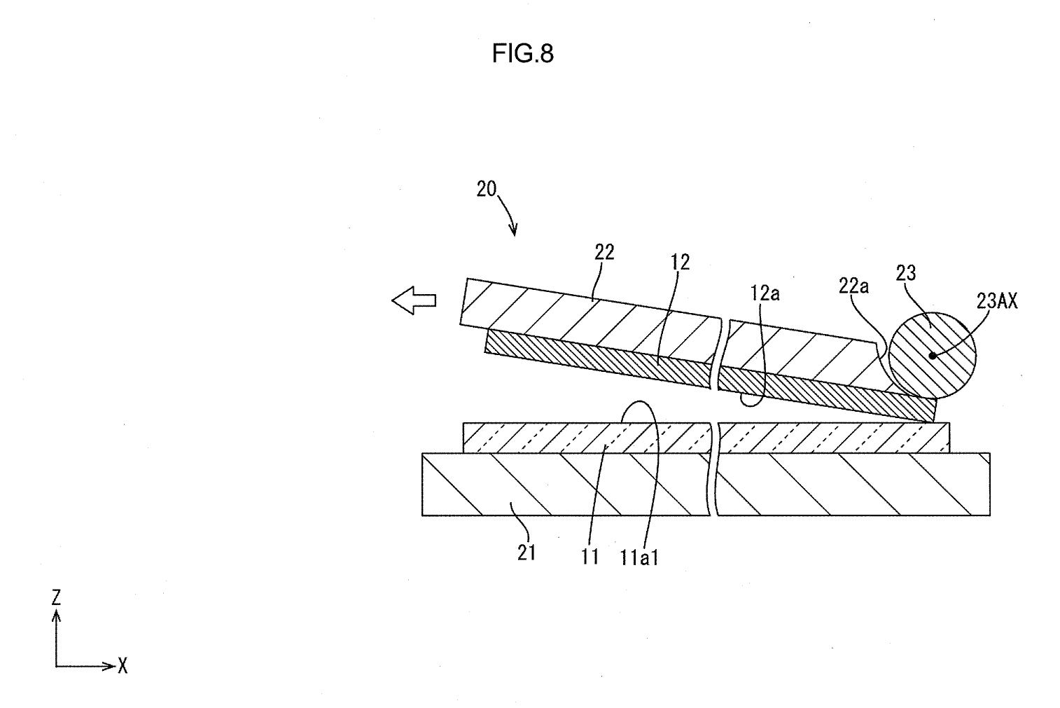

The polarizing plate support stage 22 includes a tilting mechanism (not shown) that moves the polarizing plate support stage 22 between an initial position and a bonding position. In the initial position, the plate surface of the polarizing plate 12 is parallel to the bonding surface 11a1 of the liquid crystal panel 11 as shown in FIG. 4. In the bonding position, the plate surface of the polarizing plate 12 is tilted to the bonding surface 11a1 of the liquid crystal panel 11. Since the polarizing plate support stage 22 supports the polarizing plate 12 with an end portion protruding outward, this protruded portion makes contact with the liquid crystal panel 11 in the bonding position described above (see FIG. 8). Thus the polarizing plate 12 can be bonded to the liquid crystal panel 11. A roller receiving recess 22a that receives the pressure roller 23 to be described later is formed in an end portion of the polarizing plate support stage 22 on the side to which the polarizing plate 12 protrudes outward (a right side in FIG. 4 and FIG. 6). This polarizing plate support stage 22 is configured to be movable in the horizontal direction, i.e., along the bonding surface 11a1 relative to the panel support stage 21 by the moving mechanism to be described later. More specifically, the polarizing plate support stage 22 is moved to the left side along the direction of X-axis shown in FIG. 4, FIG. 6, and FIG. 7 during the bonding. The polarizing plate support stage 22 includes positioning pins (not shown) for the positioning of the polarizing plate 12 in directions along its plate surface.

The pressure roller 23 is accommodated in the roller receiving recess 22a of the polarizing plate support stage 22 mentioned above as shown in FIG. 4, and pivotally supported such as to be rotatable around a rotation axis 23AX. The pressure roller 23 has a substantially circular cross-sectional shape in a section cut along a plane orthogonal to the rotation axis 23AX, and is substantially in the form of a column extending along the rotation axis 23AX. The pressure roller 23 has a length that is at least larger than either of the short sides of the polarizing plate 12 and liquid crystal panel 11. The pressure roller 23 includes a lift mechanism (not shown) so as to be able to move up and down along the vertical direction in coordination with (following) the tilting of the polarizing plate support stage 22 caused by the tilting mechanism. This lift mechanism adjusts the position in the vertical direction of the pressure roller 23, as well as the load applied to the polarizing plate 12. The pressure roller 23 is configured to be movable with the polarizing plate support stage 22 in the horizontal direction, i.e., along the bonding surface 11a1 relative to the panel support stage 21 by the moving mechanism to be described later. More specifically, the roller is moved to the left side along the direction of X-axis shown in FIG. 4, FIG. 6, and FIG. 7 during the bonding. Namely, the pressure roller 23 is moved by the moving mechanism relative to the panel support stage 21, in coordination with (following) the polarizing plate support stage 22.

The moving mechanism may include a servo motor and the like and configured to move the polarizing plate support stage 22 and pressure roller 23 each relative to the panel support stage 21 along the horizontal direction. The direction of movement of the polarizing plate support stage 22 and pressure roller 23 by the moving mechanism relative to the panel support stage 21 (direction of X-axis shown in FIG. 5 to FIG. 7) is orthogonal to the rotation axis 23AX (direction of Y-axis shown in FIG. 6 and FIG. 7) of the pressure roller 23.

The pressure roller 23 included in the polarizing plate bonding apparatus 20 of this embodiment is disposed such that its rotation axis 23AX is inclined to each of the pair of sides 12LS and 12SS that form the corner 12C of the polarizing plate 12, as shown in FIG. 6 and FIG. 7. FIG. 6 and FIG. 7 indicate the direction of Y-axis parallel to the rotation axis 23AX of the pressure roller 23. With this configuration, the pressure roller makes contact with the corner 12C formed by the pair of sides 12LS and 12SS of the polarizing plate 12 at the start and end of bonding of the polarizing plate 12 to the liquid crystal panel 11. The contact area of the pressure roller 23 with the polarizing plate 12 (overlapping area of the polarizing plate 12 and pressure roller 23 in FIG. 6 and FIG. 7) is at least shorter than either of the lengths of the sides 12LS and 12SS of the polarizing plate 12. With the contact area of the pressure roller 23 with the polarizing plate 12 being made sufficiently small like this, air is hardly entrapped between the polarizing plate 12 and the liquid crystal panel 11. Thus, air is hardly entrapped between the polarizing plate 12 and the liquid crystal panel 11 at the start and end of bonding of the polarizing plate 12 to the liquid crystal panel 11 when the possibility of air entrapment is particularly high, and accordingly air bubble formation is favorably suppressed.

To be specific, the pressure roller 23 is arranged such that its rotation axis 23AX is inclined to each of the pair of sides 12LS and 12SS of the polarizing plate 12 within the range from 2° to 88°, as shown in FIG. 6 and FIG. 7. Specifically, the pressure roller 23 is arranged such that its rotation axis 23AX makes a sharp angle with each of the pair of sides 12LS and 12SS of the polarizing plate 12, wherein the inclination angle (θ1) of the rotation axis 23AX relative to the short side 12SS of the polarizing plate 12 is relatively small and is 2° or more, while the inclination angle (θ2) of the rotation axis 23AX relative to the long side 12LS of the polarizing plate 12 is relatively large and is 88° or less. With this configuration, the contact area of the pressure roller 23 with the corner 12C of the polarizing plate 12 is made sufficiently short at the start and end of bonding of the polarizing plate 12 to the liquid crystal panel 11, so that air bubble formation is suppressed more favorably. Here, the formulae of θ1<θ2, and θ1+θ2=90° are satisfied, where θ1 represents the inclination angle of the rotation axis 23AX relative to the short side 12SS of the polarizing plate 12, and θ2 represents the inclination angle of the rotation axis 23AX relative to the long side 12LS of the polarizing plate 12. Namely, θ1 and θ2 are both smaller than 90°, and the larger θ1 is made, the smaller θ2 becomes, while the smaller θ1 is made, the larger θ2 becomes.

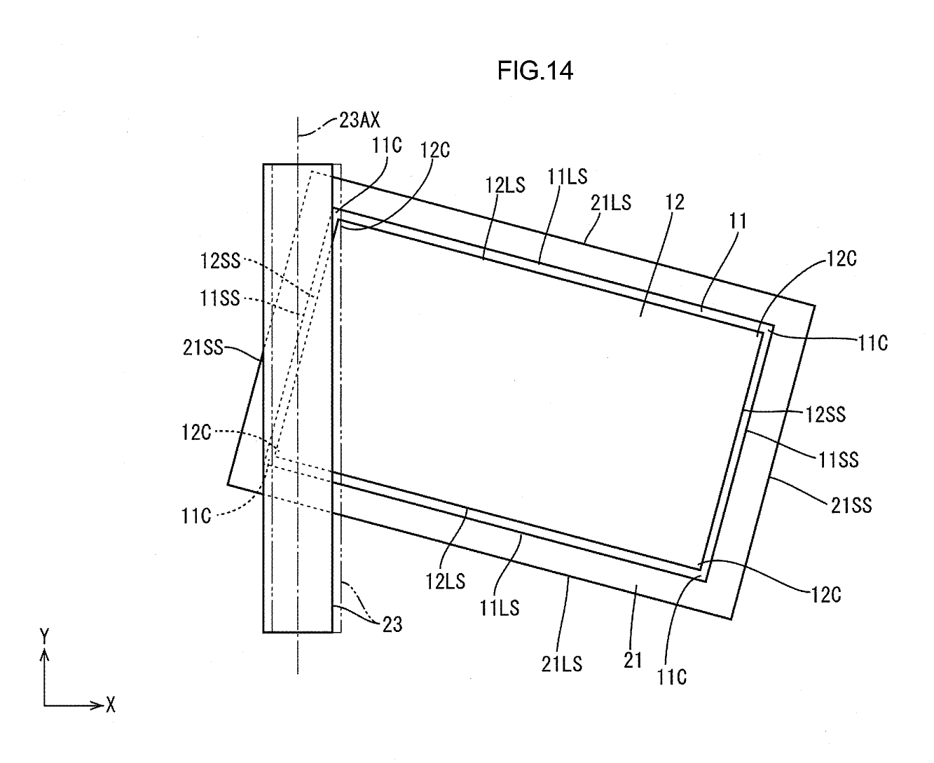

In relation to the pressure roller 23 thus disposed, the polarizing plate 12 is arranged, as shown in FIG. 6 and FIG. 7, such that the pair of corners 12C that are not diagonal to each other but formed by the same short side 12SS (pair of corners 12C located at both ends of the short side 12SS) are offset front to back relative to the direction of movement of the polarizing plate support stage 22 and pressure roller 23 relative to the panel support stage 21 by the moving mechanism (left and right direction in FIG. 6 and FIG. 7). The distance in the moving direction specified above between the pair of corners 12C of the polarizing plate 12 that are not diagonal to each other but formed by the same short side 12SS can be determined by a formula of L·sin θ, where L represents the length of the short side of the polarizing plate 12, and θ represents the inclination angle of the rotation axis 23AX of the pressure roller 23 relative to the short side 12SS of the polarizing plate 12. The inclination angle θ of the rotation axis 23AX of the pressure roller 23 relative to the short side 12SS of the polarizing plate 12 is set such that the distance in the moving direction between the pair of corners 12C specified above is equal to or smaller than the width of the pressure roller 23. Namely, the inclination angle θ of the rotation axis 23AX of the pressure roller 23 relative to the short side 12SS of the polarizing plate 12 satisfies a formula of W≥L·sin θ, where W represents the width of the pressure roller 23. With this configuration, when the bonding of the polarizing plate 12 to the liquid crystal panel 11 is started, the pair of corners 12C of the polarizing plate 12, which are positioned front and back relative to the direction of movement by the moving mechanism and which are not diagonal to each other but formed by the same short side 12SS, are pressed by the pressure roller 23 at the same timing (see two dot chain line shown in FIG. 9 and FIG. 14). In this way, air is hardly entrapped between part of the polarizing plate 12, particularly between the pair of corners 12C noted above, and the liquid crystal panel 11, so that air bubble formation is suppressed favorably.

The polarizing plate support stage 22 includes a pair of sides 22LS and 22SS that are respectively parallel to the pair of sides 12LS and 12SS of the polarizing plate 12 that form the corner 12C as shown in FIG. 6 and FIG. 7. The polarizing plate support stage 22 has a horizontally long quadrate shape when viewed in plan similarly to the polarizing plate 12, and its long sides 22LS and short sides 22SS are respectively parallel to the long sides 12LS and short sides 12SS of the polarizing plate 12. Namely, the polarizing plate support stage 22 has an outer shape similar to that of the polarizing plate 12 with larger outer dimensions than the polarizing plate 12. With this configuration, the polarizing plate 12 is positioned highly accurately by being supported by the polarizing plate support stage 22 such that the pair of sides 12LS and 12SS that form the corner 12C of the polarizing plate 12 are parallel to the pair of sides 22LS and 22SS of the polarizing plate support stage 22. In other words, the degree of positioning precision of the polarizing plate 12 can be determined by measuring the degree of parallelism of each side 12LS and 12SS of the polarizing plate 12 relative to each side 22LS and 22SS of the polarizing plate support stage 22, which is advantageous in improving positional accuracy. In this way, misalignment of the polarizing plate 12 relative to the liquid crystal panel 11 hardly occurs.

The panel support stage 21 includes a pair of sides 21LS and 21SS that are respectively parallel to the pair of sides 11LS and 11SS of the liquid crystal panel 11 that form the corner 11C as shown in FIG. 5. The panel support stage 21 has a horizontally long quadrate shape when viewed in plan similarly to the liquid crystal panel 11, and its long sides 21LS and short sides 21SS are respectively parallel to the long sides 11LS and short sides 11SS of the liquid crystal panel 11. Namely, the panel support stage 21 has an outer shape similar to that of the liquid crystal panel 11 with larger outer dimensions than the liquid crystal panel 11. With this configuration, the liquid crystal panel 11 is positioned highly accurately by being supported by the panel support stage 21 such that the pair of sides 11LS and 11SS that form the corner 11C of the liquid crystal panel 11 are parallel to the pair of sides 21LS and 21SS of the panel support stage 21. In other words, the degree of positioning precision of the liquid crystal panel 11 can be determined by measuring the degree of parallelism of each side 11LS and 11SS of the liquid crystal panel 11 relative to each side 21LS and 21SS of the panel support stage 21, which is advantageous in improving positional accuracy. In this way, misalignment of the liquid crystal panel 11 relative to the polarizing plate 12 hardly occurs.

Next, the polarizing plate bonding method (sheet member bonding method) for bonding the polarizing plate 12 to the liquid crystal panel 11 using the polarizing plate bonding apparatus 20 configured as described above will be explained. In the polarizing plate bonding method according to this embodiment, first, as shown in FIG. 4, the liquid crystal panel 11 is supported on the panel support stage 21 such that the bonding surface 11a1 to which the polarizing plate 12 is to be bonded faces upward in the vertical direction (a Z-axis direction shown in FIG. 4), while the polarizing plate 12 is supported on the polarizing plate support stage 22 in its initial position in which the bonding layer faces downward in the vertical direction, so that the bonding layer of the polarizing plate 12 is located opposite the bonding surface 11a1 of the liquid crystal panel 11. Next, the polarizing plate support stage 22 in the initial position is tiltedly moved to the bonding position so as to cause an end portion of the polarizing plate 12 to make contact with the bonding surface 11a1 of the liquid crystal panel 11, as well as the pressure roller 23, which was synchronizing the polarizing plate support stage 22 to the initial position, is lowered along the vertical direction into contact with the end portion of the polarizing plate 12, as shown in FIG. 8. The end portion of the polarizing plate 12 is pressed by the predetermined load applied by the pressure roller 23, so that the bonding to the bonding surface 11a1 of the liquid crystal panel 11 is started. In FIG. 8 to FIG. 12, the moving direction of the polarizing plate support stage 22 and the pressure roller 23 that are moved by the moving mechanism is indicated with an arrow.

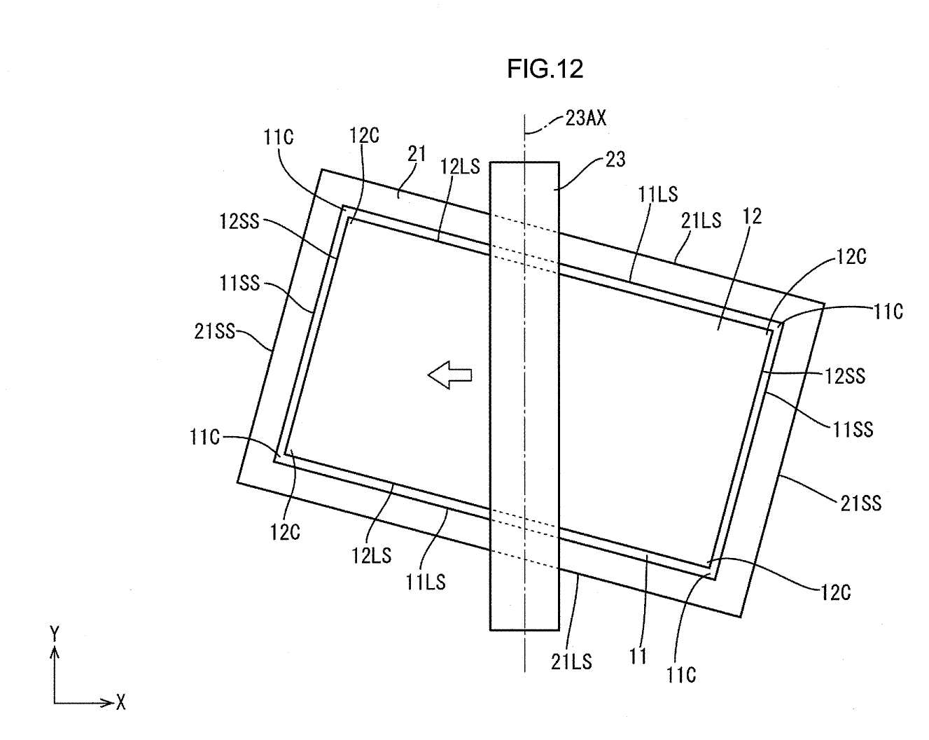

Since the rotation axis 23AX of the pressure roller 23 is inclined to each of the pair of sides 12LS and 12SS that form the corner 12C of the polarizing plate 12 as shown in FIG. 9, the pressure roller makes contact mainly with the corner 12C formed by a pair of sides 12LS and 12SS of the polarizing plate 12 (specifically, upper right corner 12C shown in FIG. 9), which is at the foremost end in the moving direction, at the start of bonding of the polarizing plate 12 to the liquid crystal panel 11. The contact area of the pressure roller 23 with the polarizing plate 12 at this time is the area where a strip-like area of a predetermined width around of the rotation axis 23AX of the pressure roller 23 (slightly smaller than the maximum width of the pressure roller 23) overlaps with the polarizing plate 12, which includes the corner 12C at the foremost end in the moving direction, and is substantially triangular when viewed in plan. Accordingly, the contact area of the pressure roller 23 with the polarizing plate 12 at the start of bonding is at least shorter than either of the lengths of the sides 12LS and 12SS of the polarizing plate 12. With the contact area of the pressure roller 23 with the polarizing plate 12 being made sufficiently small like this, air is hardly entrapped between the polarizing plate 12 and the liquid crystal panel 11. Thus, air is hardly entrapped between the polarizing plate 12 and the liquid crystal panel 11 at the start of bonding of the polarizing plate 12 to the liquid crystal panel 11 when the possibility of air entrapment is particularly high, and accordingly air bubble formation is favorably suppressed. The polarizing plate support stage 22 is not illustrated in FIG. 9, FIG. 12, and FIG. 14 so that the positional relationship between the polarizing plate 12 and the pressure roller 23 is more visible.

Successively, the polarizing plate support stage 22 and pressure roller 23 are moved by the moving mechanism to the left side in FIG. 8 and FIG. 9 along the X-axis direction relative to the panel support stage 21. Here, the inclination angle θ of the rotation axis 23AX of the pressure roller 23 relative to the short side 12SS of the polarizing plate 12 satisfies a formula of W≥L·sin θ, where L represents the length of the short sides of the polarizing plate 12 and W represents the width of the pressure roller 23. Therefore, when the polarizing plate support stage 22 and pressure roller 23 are moved by the moving mechanism with the start of the bonding of the polarizing plate 12 as noted above, the pair of corners 12C of the polarizing plate 12, which are positioned front and back relative to the moving direction and which are not diagonal to each other but formed by the same short side 12SS, are pressed by the pressure roller 23 at the same timing as indicated by the two dot chain line in FIG. 9. In this way, air is hardly entrapped between part of the polarizing plate 12, particularly between the pair of corners 12C noted above, and the liquid crystal panel 11, so that air bubble formation is suppressed favorably.

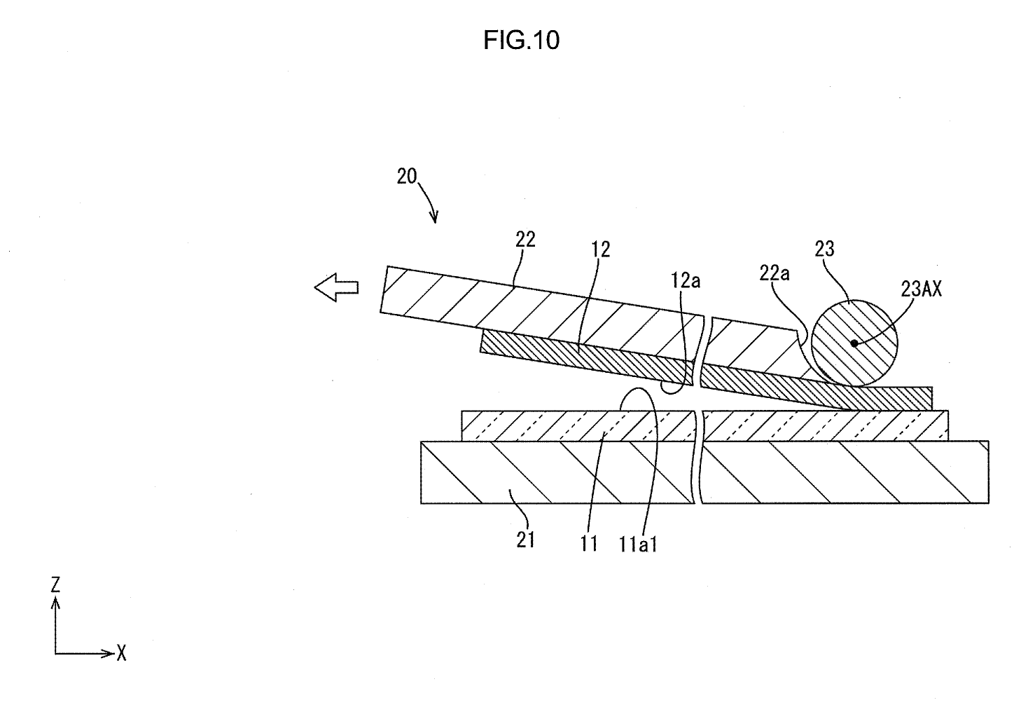

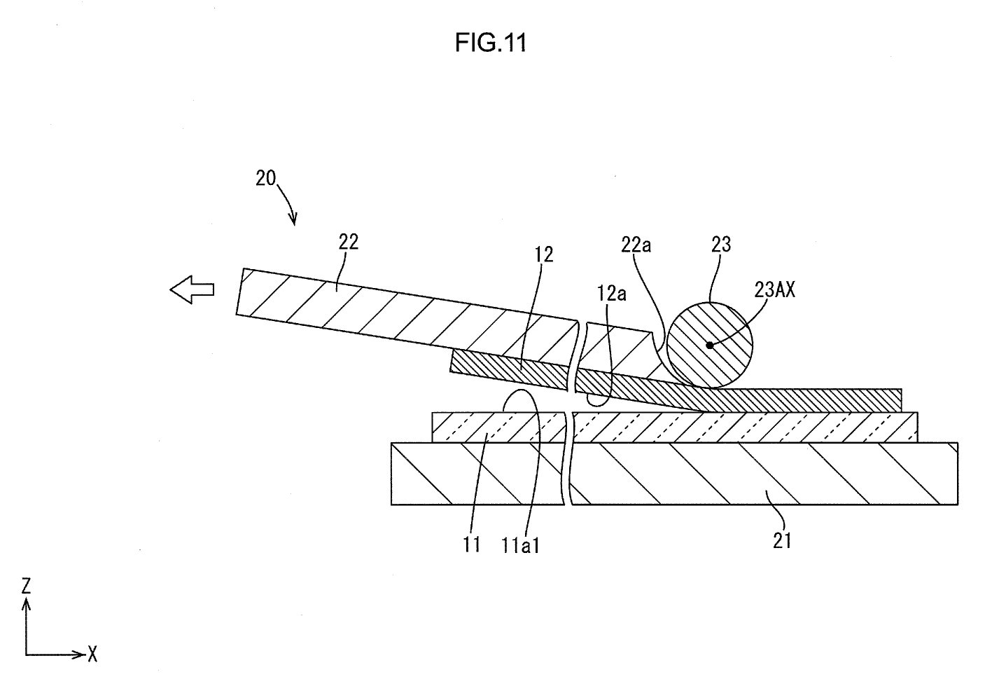

By the time the polarizing plate support stage 22 and pressure roller 23 are moved by the moving mechanism along the X-axis direction relative to the panel support stage 21, part of the polarizing plate 12 has already been bonded to the bonding surface 11a1 of the liquid crystal panel 11 by being pressed by the pressure roller 23. Accordingly, the polarizing plate support stage 22 and pressure roller 23 move relative to the polarizing plate 12, liquid crystal panel 11, and panel support stage 21 as shown in FIG. 10. With this movement, the pressure roller 23 rotates around the rotation axis 23AX and presses the polarizing plate 12, whereby the bonding of the polarizing plate 12 is performed. As the bonding of the polarizing plate 12 is performed, the contact area of the pressure roller 23 with the polarizing plate 12 is gradually extended. When the pressure roller 23 moves past the corner 12C second from the foremost end (right side of FIG. 12) in the moving direction, the contact area becomes substantially constant, as shown in FIG. 11 and FIG. 12.

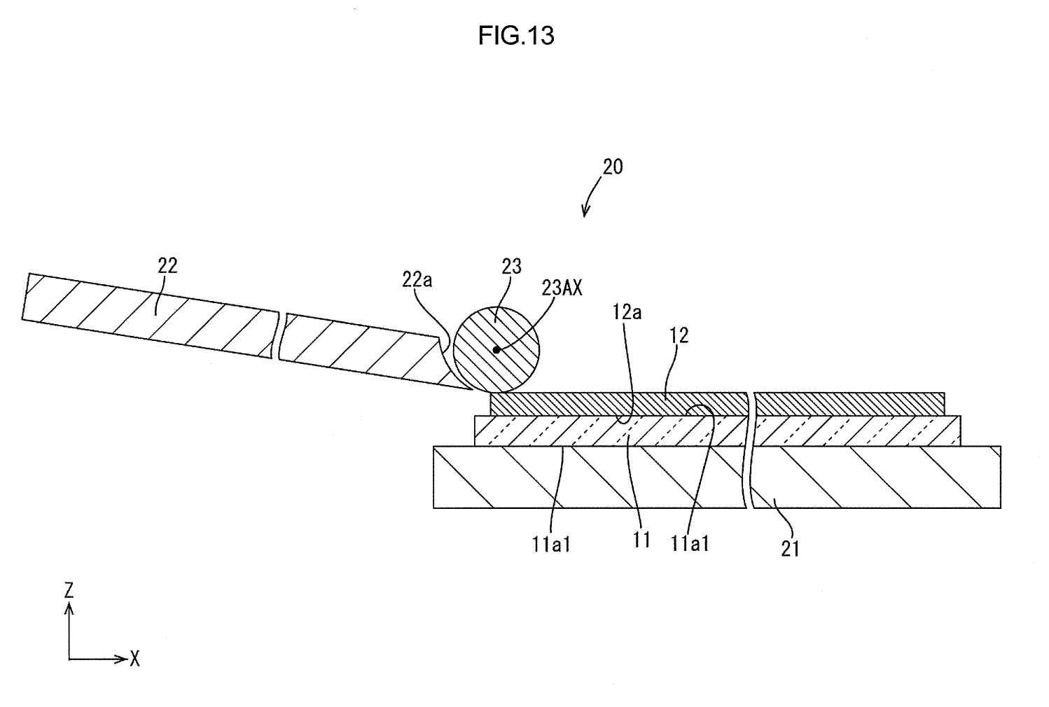

The bonding of the polarizing plate 12 has been performed and when the pressure roller 23 moves past the corner 12C second from the rearmost end (left side of FIG. 12) of the polarizing plate 12 in the moving direction, the contact area of the pressure roller 23 with the polarizing plate 12 is gradually decreased. When the pressure roller 23 reaches the corner 12C of the polarizing plate 12 at the rearmost end of the moving direction, the contact area becomes the smallest as shown in FIG. 13 and FIG. 14, and the bonding of the polarizing plate 12 is finished. The contact area of the pressure roller 23 with the polarizing plate 12 at the end of the bonding is substantially the same as the contact area at the start of the bonding. Namely, the contact area of the pressure roller 23 with the polarizing plate 12 at the end of bonding, similarly to that at the start of bonding, is at least shorter than either of the lengths of the sides 12LS and 12SS of the polarizing plate 12. With the contact area of the pressure roller 23 with the polarizing plate 12 being made sufficiently small like this, air is hardly entrapped between the polarizing plate 12 and the liquid crystal panel 11. Thus, air is hardly entrapped between the polarizing plate 12 and the liquid crystal panel 11 at the end of bonding of the polarizing plate 12 to the liquid crystal panel 11 when the possibility of air entrapment is particularly high, and accordingly air bubble formation is favorably suppressed.

Immediately before the bonding of the polarizing plate 12 is ended, the pair of corners 12C of the polarizing plate 12, which are positioned front and back relative to the moving direction and which are not diagonal to each other but formed by the same short side 12SS, are pressed by the pressure roller 23 at the same timing as indicated with the two dot chain line in FIG. 14. This is because, as has been described, the inclination angle θ of the rotation axis 23AX of the pressure roller 23 relative to the short side 12SS of the polarizing plate 12 satisfies the formula of W≥L·sin θ, where L represents the length of the short sides of the polarizing plate 12 and W represents the width of the pressure roller 23. In this way, air is hardly entrapped between part of the polarizing plate 12, particularly between the pair of corners 12C noted above, and the liquid crystal panel 11, so that air bubble formation is suppressed more favorably.

After the polarizing plate 12 is bonded on one bonding surface 11a1 of the liquid crystal panel 11 as described above, the liquid crystal panel 11 is supported on the panel support stage 21 upside down. After that, the polarizing plate 12 is bonded to the other bonding surface 11a1 in accordance with the procedure described above. Thus the liquid crystal panel 11 with polarizing plates 12 bonded to each of the front and back bonding surfaces 11a1 is produced.

As described above, the polarizing plate bonding apparatus (sheet member bonding apparatus) 20 of this embodiment includes a panel support stage (panel support unit) 21 that supports a liquid crystal panel (display panel) 11, a polarizing plate support stage (sheet support unit) 22 that supports a polarizing plate 12 having at least a pair of sides 12LS and 12SS and a corner 12C formed by the pair sides 12LS and 12SS such as to face a bonding surface 11a1 of the liquid crystal panel 11, a rotatable pressure roller 23 that presses the polarizing plate 12 against the liquid crystal panel 11, the pressure roller 23 having a rotation axis 23AX inclined to each of the pair of sides 12LS and 12SS of the polarizing plate 12, and a moving mechanism for relatively moving the panel support stage 21, and the polarizing plate support stage 22 and the pressure roller 23 along the bonding surface 11a1.

When bonding the polarizing plate 12 on the liquid crystal panel 11 with the polarizing plate bonding apparatus 20 configured as described above, first, the polarizing plate 12 supported by the polarizing plate support stage 22 is positioned opposite the bonding surface 11a1 of the liquid crystal panel 11 supported by the panel support stage 21. The polarizing plate 12 is pressed against the liquid crystal panel 11 with the pressure roller 23 in this state, and as the panel support stage 21, the polarizing plate support stage 22, and pressure roller 23 are relatively moved by the moving mechanism along the bonding surface 11a1, the pressure roller 23 is rotated, so that the bonding of the polarizing plate 12 to the liquid crystal panel 11 is performed. The rotation axis 23AX of the pressure roller 23 is inclined to each of the pair of sides 12LS and 12SS of the polarizing plate 12, so that the pressure roller makes contact with the corner 12C formed by the pair of sides 12LS and 12SS of the polarizing plate 12 at the start and end of bonding of the polarizing plate 12 to the liquid crystal panel 11. The contact area at this time is at least shorter than any of the lengths of the sides of the polarizing plate 12. With the contact area of the pressure roller 23 with the polarizing plate 12 being made sufficiently small like this, air is hardly entrapped between the polarizing plate 12 and the liquid crystal panel 11. Thus, air is hardly entrapped between the polarizing plate 12 and the liquid crystal panel 11 at the start and end of bonding of the polarizing plate 12 to the liquid crystal panel 11 when the possibility of air entrapment is particularly high, and accordingly air bubble formation is favorably suppressed.

The pressure roller 23 is arranged such that its rotation axis 23AX is inclined to each of the pair of sides 12LS and 12SS of the polarizing plate 12 within the range from 2° to 88°. In this way, the contact area of the pressure roller 23 with the corner 12C of the polarizing plate 12 is made sufficiently short at the start and end of bonding of the polarizing plate 12 to the liquid crystal panel 11, so that air bubble formation is suppressed more favorably.

The rotation axis 23AX of the pressure roller 23 is inclined to each of the pair of sides 12LS and 12SS of the polarizing plate 12 such that the distance in the moving direction between the pair of corners 12C of the quadrate polarizing plate 12 that are positioned front and back in the direction of movement by the moving mechanism and which are not diagonal to each other is equal to or smaller than the width of the pressure roller 23. In this way, when the bonding of the polarizing plate 12 to the liquid crystal panel 11 is started, the pair of corners 12C of the quadrate polarizing plate 12, which are positioned front and back relative to the direction of movement by the moving mechanism and which are not diagonal to each other, are pressed by the pressure roller 23 at the same timing. In this way, air is hardly entrapped between part of the polarizing plate 12, particularly between the pair of corners 12C noted above, and the liquid crystal panel 11, so that air bubble formation is suppressed more favorably.

The polarizing plate support stage 22 includes a pair of sides 22LS and 22SS that are respectively parallel to the pair of sides 12LS and 12SS of the polarizing plate 12. In this way, the polarizing plate 12 is positioned highly accurately by being supported by the polarizing plate support stage 22 such that the pair of sides 12LS and 12SS of the polarizing plate 12 are parallel to the pair of sides 22LS and 22SS of the polarizing plate support stage 22. In this way, misalignment of the polarizing plate 12 relative to the liquid crystal panel 11 hardly occurs.

The panel support stage 21 includes a pair of sides 21LS and 21SS that are respectively parallel to the pair of sides 11LS and 11SS of the liquid crystal panel 11. In this way, the liquid crystal panel 11 is positioned highly accurately by being supported by the panel support stage 21 such that the pair of sides 11LS and 11SS of the liquid crystal panel 11 are parallel to the pair of sides 21LS and 21SS of the panel support stage 21. In this way, misalignment of the liquid crystal panel 11 relative to the polarizing plate 12 hardly occurs.

According to the polarizing plate bonding method (sheet member bonding method) of this embodiment, a polarizing plate 12, which includes at least a pair of sides 12LS and 12SS and a corner 12C formed by the pair of sides 12LS and 12SS, and is supported by a polarizing plate support stage 22, is positioned opposite a bonding surface 11a1 of a liquid crystal panel 11 supported by a panel support stage 21. The polarizing plate 12 is pressed against the liquid crystal panel 11 by the pressure roller 23. When the pressure roller 23 is rotated while the panel support stage 21, the polarizing plate support stage 22, and pressure roller 23 are relatively moved by the moving mechanism along the bonding surface 11a1, the rotation axis 23AX of the pressure roller 23 is inclined to each of the pair of sides 12LS and 12SS of the polarizing plate 12.

With this sheet member bonding method, first, the polarizing plate 12 supported by the polarizing plate support stage 22 is positioned opposite the bonding surface 11a1 of the liquid crystal panel 11 supported by the panel support stage 21. The polarizing plate 12 is pressed against the liquid crystal panel 11 with the pressure roller 23 in this state, and as the panel support stage 21, the polarizing plate support stage 22, and pressure roller 23 are relatively moved by the moving mechanism along the bonding surface 11a1, the pressure roller 23 is rotated, so that the bonding of the polarizing plate 12 on the liquid crystal panel 11 progresses. The rotation axis 23AX of the pressure roller 23 is inclined to each of the pair of sides 12LS and 12SS of the polarizing plate 12, so that the pressure roller makes contact with the corner 12C formed by the pair of sides 12LS and 12SS of the polarizing plate 12 at the start and end of bonding of the polarizing plate 12 to the liquid crystal panel 11. The contact area at this time is at least shorter than any of the lengths of the sides of the polarizing plate 12. With the contact area of the pressure roller 23 with the polarizing plate 12 being made sufficiently small like this, air is hardly entrapped between the polarizing plate 12 and the liquid crystal panel 11. Thus, air is hardly entrapped between the polarizing plate 12 and the liquid crystal panel 11 at the start and end of bonding of the polarizing plate 12 to the liquid crystal panel 11 when the possibility of air entrapment is particularly high, and accordingly air bubble formation is favorably suppressed.

### Embodiment 2

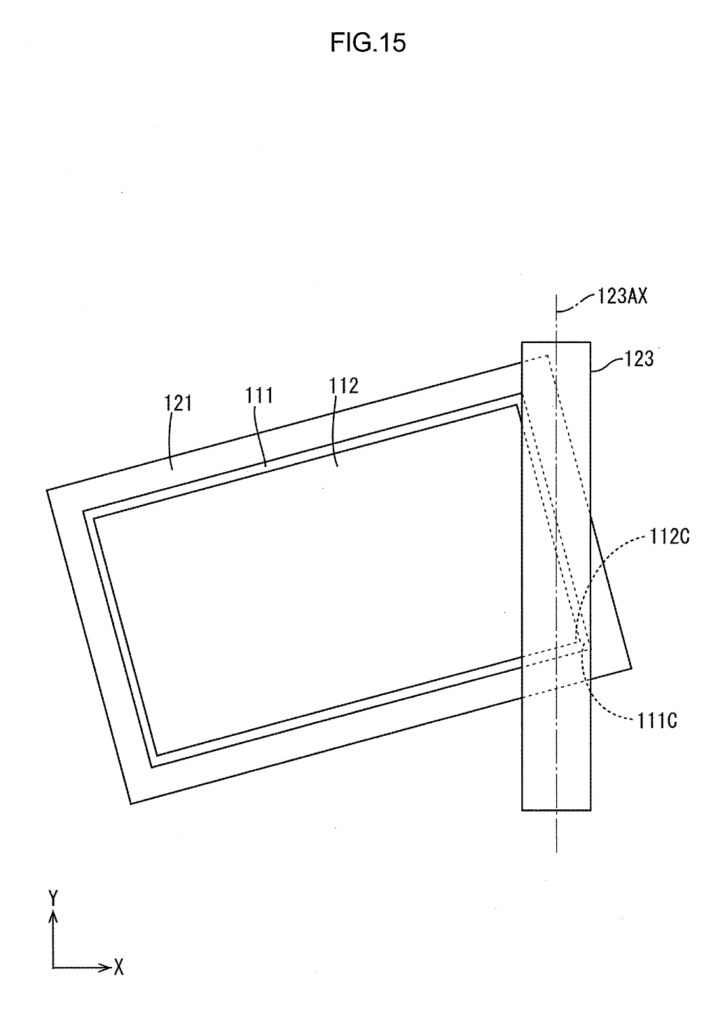

Embodiment 2 of the present invention will be described with reference to FIG. 15. Embodiment 2 will illustrate an arrangement in which the position of the panel support stage 121 and polarizing plate support stage relative to the pressure roller 123 is changed. Repeated description of the structures, effects, and advantages similar to those of the previously described Embodiment 1 will be omitted.

The panel support stage 121 according to this embodiment is configured such that the lower right corner 111C of the liquid crystal panel 111 is positioned foremost in the moving direction as shown in FIG. 15. Although not shown, the polarizing plate support stage is configured similarly to the panel support stage 121, so that the lower right corner 112C of the polarizing plate 112 shown in FIG. 15 is positioned foremost in the moving direction and pressed first by the pressure roller 123. Namely, the panel support stage 121 and polarizing plate support stage are line-symmetric with those of Embodiment 1 described above about a line in the direction orthogonal to the rotation axis 123AX of the pressure roller 123 (X-axis direction).

### Embodiment 3

Embodiment 3 of the present invention will be described with reference to FIG. 16. Embodiment 3 will illustrate a pressure roller 223 whose diameter is changed from that of Embodiment 1 described above. Repeated description of the structures, effects, and advantages similar to those of the previously described Embodiment 1 will be omitted.

The pressure roller 223 according to this embodiment has a larger diameter than that of Embodiment 1 described above as shown in FIG. 16. In this way, air bubble formation can be suppressed even more preferably.

### Embodiment 4

Embodiment 4 of the present invention will be described with reference to FIG. 17. Embodiment 4 will illustrate a pressure roller 323 whose material is changed from that of Embodiment 1 described above. Repeated description of the structures, effects, and advantages similar to those of the previously described Embodiment 1 will be omitted.

The pressure roller 323 according to this embodiment is made of an elastic material as shown in FIG. 17, so that the surface hardness is lower (softer) than that of Embodiment 1 described above. The pressure roller 323 therefore makes tighter contact with a polarizing plate 312. Thus, air is more hardly entrapped between the polarizing plate 312 and the liquid crystal panel 311 at the start and end of bonding of the polarizing plate 312 to the liquid crystal panel 311, and accordingly air bubble formation is more favorably suppressed.

As described above, the pressure roller 323 according to this embodiment is provided with an elastic material at least on a surface thereof. In this way, the pressure roller 323 makes tighter contact with the polarizing plate 312, so that air is more hardly entrapped between the polarizing plate 312 and the liquid crystal panel 311 at the start and end of bonding of the polarizing plate 312 to the liquid crystal panel 311, and accordingly air bubble formation is more favorably suppressed.

### Embodiment 5

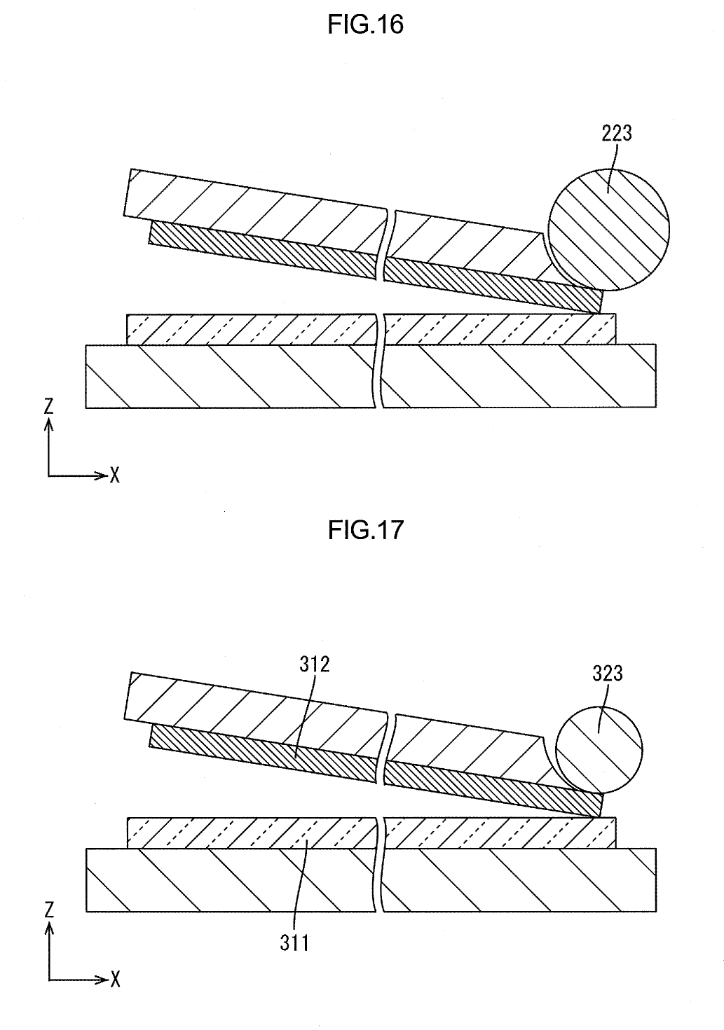

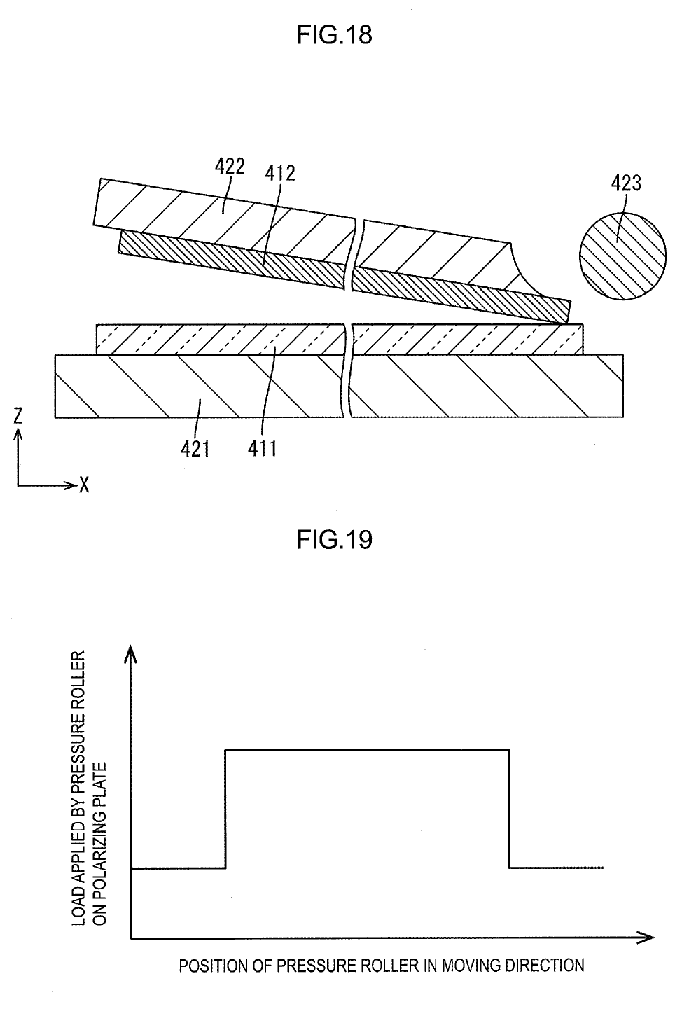

Embodiment 5 of the present invention will be described with reference to FIG. 18. Embodiment 5 will illustrate a pressure roller 423 whose position is changed from that of Embodiment 1 described above. Repeated description of the structures, effects, and advantages similar to those of the previously described Embodiment 1 will be omitted.

The pressure roller 423 according to this embodiment is positioned away from the polarizing plate 412 at the start of bonding of a polarizing plate 412 to a liquid crystal panel 411 as shown in FIG. 18. More specifically, when a polarizing plate support stage 422 is in its bonding position and the end portion of the polarizing plate 412 is in contact with the liquid crystal panel 411, the pressure roller 423 is spaced from the polarizing plate 412 on the front side of the moving direction of the panel support stage 421 relative to the polarizing plate support stage 422 and pressure roller 423 moved by the moving mechanism. When the polarizing plate support stage 422 and pressure roller 423 are moved by the moving mechanism from this state, the polarizing plate 412 is pressed gradually by the pressure roller 423 from the tip of the corner positioned foremost of the moving direction. Thus, air is more hardly entrapped between the polarizing plate 412 and the liquid crystal panel 411 at the start of bonding, and accordingly air bubble formation is more favorably suppressed.

As described above, according to this embodiment, the pressure roller 423 is spaced from the corner of the polarizing plate 412 on the front side of the moving direction of the panel support stage 421 relative to the polarizing plate support stage 422 and pressure roller 423 moved by the moving mechanism at the start of bonding of the polarizing plate 412 to the liquid crystal panel 411. In this way, when the bonding of the polarizing plate 412 to the liquid crystal panel 411 is started, the pressure roller 423 is not in contact with the corner of the polarizing plate 412. After the bonding has started, the pressure roller 423 is brought into contact with the corner of the polarizing plate 412 from the front side of the moving direction of the panel support stage 421 relative to the polarizing plate support stage 422 and pressure roller 423 moved by the moving mechanism. The polarizing plate 412 is therefore pressed gradually by the pressure roller 423 from the tip of the corner, so that air is more hardly entrapped between the polarizing plate 412 and the liquid crystal panel 411 at the start of bonding, and accordingly air bubble formation is more favorably suppressed.

### Embodiment 6

Embodiment 6 of the present invention will be described with reference to FIG. 19 to FIG. 21. Embodiment 6 will illustrate a pressure roller whose load applied on a polarizing plate is changed from that of Embodiment 1 described above. Repeated description of the structures, effects, and advantages similar to those of the previously described Embodiment 1 will be omitted.

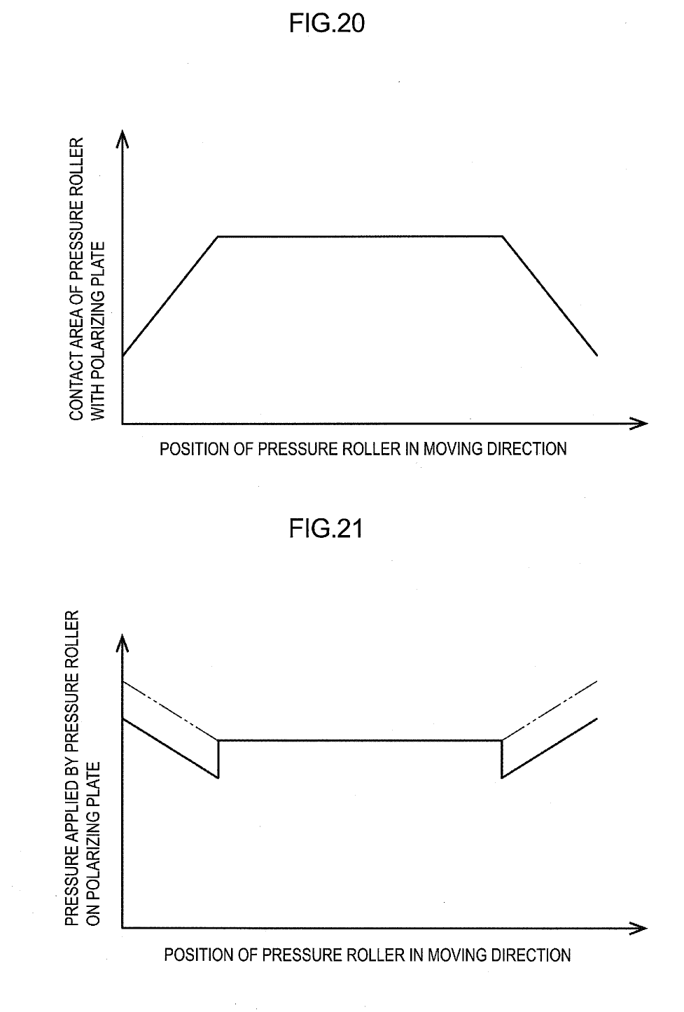

The load applied by the pressure roller according to this embodiment on a polarizing plate is made smaller at the start and at the end of bonding of the polarizing plate to a liquid crystal panel than the middle of the bonding as shown in FIG. 19. More specifically, the load applied by the pressure roller on the polarizing plate is substantially the same and constant during a predetermined period at the start of bonding (in which the pressure roller moves a certain distance) and during a predetermined period at the end of bonding. The load applied in the middle of the bonding between the start and the end of bonding is relatively larger and constant. The left end position of the horizontal axis in FIG. 19 to FIG. 21 corresponds to the position where the bonding of the polarizing plate is started, while the right end position of the horizontal axis corresponds to the position where the bonding of the polarizing plate is ended. The contact area of the pressure roller with the polarizing plate is smaller at the start and end of bonding of the polarizing plate to the liquid crystal panel than the middle of the bonding as shown in FIG. 20. If the load applied from the pressure roller to the polarizing plate is the same as the maximum load in this embodiment and constant, it is concerned that the load, or pressure, per unit area applied from the pressure roller on the polarizing plate would be excessive at the start and end of bonding and the difference in pressure between the middle of the bonding and the start and end of the bonding would be too large (see two dot chain lines in the graph of FIG. 21). If the load applied from the pressure roller to the polarizing plate is made smaller at the start and end of bonding than the middle of the bonding as in this embodiment, the difference in pressure applied from the pressure roller to the polarizing plate between the start and end of bonding and the middle of the bonding is made smaller, i.e., the pressure is made more uniform, as shown in FIG. 21. In this way, the pressure applied from the pressure roller to the polarizing plate varies little during the bonding process, so that air is hardly entrapped between the polarizing plate and the liquid crystal panel during the bonding process, and accordingly air bubble formation is favorably suppressed.

As described above, according to this embodiment, the load applied by the pressure roller on the polarizing plate is made smaller at the start and end of bonding of the polarizing plate to the liquid crystal panel than the middle of the bonding. The contact area of the pressure roller with the polarizing plate is smaller at the start and end of bonding of the polarizing plate to the liquid crystal panel than the middle of the bonding. Thus, the load applied from the pressure roller to the polarizing plate at the start and end of bonding is made smaller than that at the middle of the bonding, so that the load, i.e., pressure, per unit area applied from the pressure roller to the polarizing plate is made uniform between the start and end of bonding and during the bonding. In this way, the pressure applied from the pressure roller to the polarizing plate varies little during the bonding process, so that air is hardly entrapped between the polarizing plate and the liquid crystal panel during the bonding process, and accordingly air bubble formation is favorably suppressed.

### Embodiment 7

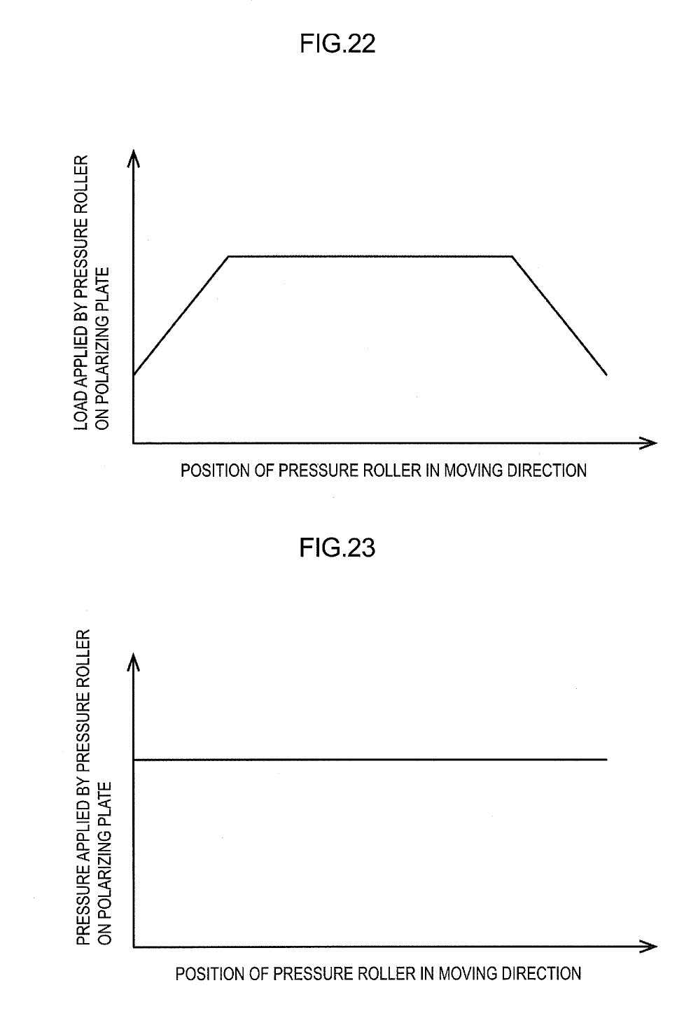

Embodiment 7 of the present invention will be described with reference to FIG. 22 or FIG. 23. Embodiment 7 will illustrate a pressure roller whose load applied on a polarizing plate is changed from that of Embodiment 6. Repeated description of the structures, effects, and advantages similar to those of the previously described Embodiment 6 will be omitted.

The load applied by the pressure roller according to this embodiment on the polarizing plate is changed at the start and end of bonding of the polarizing plate to the liquid crystal panel as shown in FIG. 22. More specifically, the load applied from the pressure roller to the polarizing plate is gradually increased continuously for a period of time from the start of bonding. On the other hand, the load applied from the pressure roller to the polarizing plate is gradually decreased continuously for a period of time until the end of bonding. The increasing rate and decreasing rate of the load from the pressure roller at the start and end of bonding are substantially equal to the increasing rate and decreasing rate of the contact area of the pressure roller with the polarizing plate (see FIG. 20). Therefore, the pressure applied from the pressure roller to the polarizing plate is substantially equal at the start and end of the bonding, and the middle of the bonding, as shown in FIG. 23, i.e., substantially constant throughout the entire bonding period. Thus, air is more hardly entrapped between the polarizing plate and the liquid crystal panel during the bonding, and accordingly air bubble formation is more favorably suppressed.

### Embodiment 8

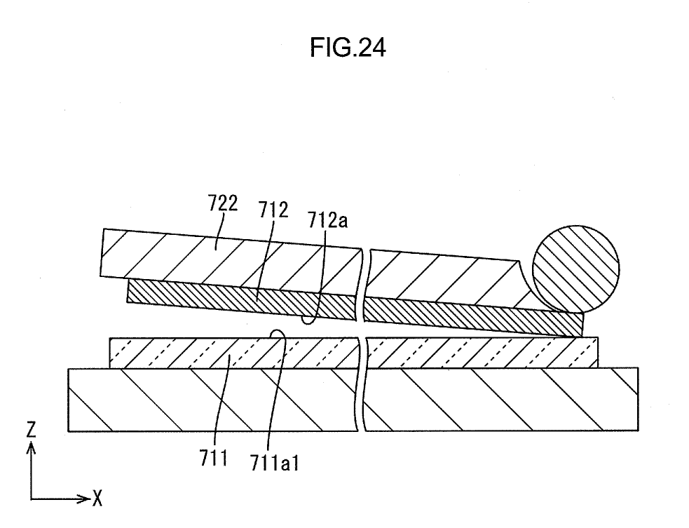

Embodiment 8 of the present invention will be described with reference to FIG. 24. Embodiment 8 will illustrate a polarizing plate support stage 722 whose bonding position is changed from that of Embodiment 1 described above. Repeated description of the structures, effects, and advantages similar to those of the previously described Embodiment 1 will be omitted.

The tilting angle of the polarizing plate support stage 722 according to this embodiment from the initial position to the bonding position is smaller than that of Embodiment 1 described above as shown in FIG. 24. More specifically, the polarizing plate support stage 722 is set such that the angle made by the bonding surface 711a1 of the liquid crystal panel 711 and the bonded surface 712a of the polarizing plate 712 in the bonding position is about half of the angle in Embodiment 1. In this way, air bubble formation can be suppressed even more preferably.

### Other Embodiment

The present invention is not limited to the embodiments illustrated by the description given above and the drawings. The following embodiments, for example, are also included in the technical scope of the present invention.

(1) In the embodiments described above, the inclination angle of the rotation axis of the pressure roller relative to the short sides of the polarizing plate is made smaller than the inclination angle relative to the long sides. Instead, the inclination angle of the rotation axis of the pressure roller relative to the short sides of the polarizing plate may be made larger than the inclination angle relative to the long sides. Alternatively, the inclination angle of the rotation axis of the pressure roller relative to the short sides of the polarizing plate may be made equal to the inclination angle relative to the long sides.

(2) In the embodiments described above, the rotation axis of the pressure roller is inclined to each of the sides of the polarizing plate within the range from 2° to 88°. Instead, the rotation axis of the pressure roller may be inclined to one side of the polarizing plate at an angle smaller than 2°, and to the other side of the polarizing plate at an angle larger than 88°.

(3) In the embodiments described above, the inclination angle θ of the rotation axis of the pressure roller relative to the short sides of the polarizing plate satisfies the formula of W≥L·sin θ, where L represents the length of the short sides of the polarizing plate and W represents the width of the pressure roller. Instead, the inclination angle θ of the rotation axis of the pressure roller relative to the short sides of the polarizing plate can satisfy a formula of W>L·sin θ, a formula of W=L·sin θ, or a formula of W<L·sin θ.

(4) In the embodiments described above, the sides of the polarizing plate are each parallel to the sides of the polarizing plate support stage. It is possible to adopt a configuration in which the sides of the polarizing plate intersect the sides of the polarizing plate support stage. In this case, some of the sides of the polarizing plate support stage may be parallel to one or more of the sides of the polarizing plate.

(5) In the embodiments described above, the sides of the liquid crystal panel are each parallel to the sides of the panel support stage. It is possible to adopt a configuration in which the sides of the liquid crystal panel intersect the sides of the panel support stage. In this case, some of the sides of the panel support stage may be parallel to one or more of the sides of the liquid crystal panel.

(6) In the embodiments described above, the polarizing plate support stage and pressure roller are moved substantially at the same timing by the moving mechanism. Instead, there may be a time difference in the movement of the polarizing plate support stage and of the pressure roller. To do this, a moving mechanism for the polarizing plate support stage and a moving mechanism for the pressure roller may be provided independently, for example. Alternatively, in a configuration in which the polarizing plate support stage and pressure roller are moved by independent moving mechanisms, the polarizing plate support stage and pressure roller may be moved substantially at the same timing.

(7) In the embodiments described above, the panel support stage is stationary while the polarizing plate support stage and pressure roller are movable and moved by the moving mechanism. Instead, the polarizing plate support stage and pressure roller may be configured stationary and the panel support stage may be configured movable and moved by a moving mechanism. Also, the panel support stage, polarizing plate support stage, and pressure roller may each be configured movable and moved by a moving mechanism.

(8) In the embodiments described above, the polarizing plate support stage and panel support stage are positioned on upper and lower sides in the vertical direction respectively. Conversely, the polarizing plate support stage and panel support stage may be positioned on lower and upper sides in the vertical direction, respectively.

(9) In the embodiments described above, the polarizing plate and liquid crystal panel have a horizontally long quadrate planar shape. The polarizing plate and liquid crystal panel may have other planar shapes such as vertically long quadrate, square, parallelogram, triangle, rhombus, pentagon and other polygons.

(10) While the pressure roller is made entirely of an elastic material in Embodiment 4 described above, the pressure roller may be configured such that its core part is made of a hard material, and only a surface part is made of an elastic material having lower hardness than the core part.

(11) In Embodiment 6 described above, the load applied by the pressure roller on the polarizing plate is made the same at the start and end of bonding. Instead, the load applied by the pressure roller on the polarizing plate may be made different between the start and the end of bonding. For example, the load may be made relatively larger at the start of bonding of the polarizing plate, while the load at the end of bonding may be made relatively smaller. Conversely, the load may be made relatively smaller at the start of bonding of the polarizing plate, while the load at the end of bonding may be made relatively larger.

(12) In Embodiment 7 described above, the changing rate of the load applied by the pressure roller is made the same at the start and end of bonding of the polarizing plate. Instead, the changing rate of the load applied by the pressure roller may be made different between the start and the end of bonding of the polarizing plate. For example, the changing rate of the load applied by the pressure roller may be made relatively larger at the start of bonding of the polarizing plate, while the changing rate of the load applied by the pressure roller at the end of bonding may be made relatively smaller. Conversely, the changing rate of the load applied by the pressure roller may be made relatively smaller at the start of bonding of the polarizing plate, while the changing rate of the load applied by the pressure roller at the end of bonding may be made relatively larger.

(13) While the polarizing plate is bonded to a TN or VA liquid crystal panel in the embodiments described above, the present invention is also applicable to bonding of a sheet member such as a polarizing plate to an IPS (In-Plane Switching) liquid crystal panel or FFS (Fringe Field Switching) liquid crystal panel.

(14) While polarizing plates are bonded as a sheet member to the liquid crystal panel in the embodiments described above, the present invention is also applicable to bonding of a touch panel or protection sheet, for example, as a sheet member to the liquid crystal panel.

(15) While a liquid crystal panel is used as the display panel in the embodiments described above, the present invention is also applicable to bonding of various sheet members to other panels such as an organic EL panel, PDP, MEMS (Micro Electro Mechanical Systems) display, EPD (Electronic Paper Display) panel, and the like.

### EXPLANATION OF SYMBOLS

11, 111, 311, 411, 711: Liquid crystal panel (display panel), 11a1, 711a1: Bonding surface, 11LS: Long side (side), 11SS: Short side (side), 12, 112, 312, 412, 712: Polarizing plate (sheet member), 12C, 112C: Corner, 12LS: Long side (side), 12SS: Short side (side), 20: Polarizing plate bonding apparatus (sheet member bonding apparatus), 21, 421: Panel support stage (panel support unit), 21LS: Long side (side), 21SS: Short side (side), 22, 422, 722: Polarizing plate support stage (sheet support unit), 22LS: Long side (side), 22SS: Short side (side), 23, 123, 223, 323, 423: Pressure roller, 23AX, 123AX: Rotation axis

1. A sheet member bonding apparatus, comprising:
a panel support unit that supports a display panel;
a sheet support unit that supports a sheet member having at least a pair of sides and a corner formed by the pair of sides such as to face a bonding surface of the display panel;
a pressure roller that is rotatable and presses the sheet member against the display panel, the pressure roller having a rotation axis inclined to each of the pair of sides of the sheet member; and
a moving mechanism that relatively moves the panel support unit, the sheet support unit, and the pressure roller along the bonding surface.

2. The sheet member bonding apparatus according to claim 1, wherein the pressure roller is arranged such that the rotation axis is inclined to each of the pair of sides of the sheet member in a range from 2° to 88°.

3. The sheet member bonding apparatus according to claim 1, wherein
the sheet member has a quadrate shape having the pair of sides and the corner includes a pair of corners that are not diagonal to each other, and
the rotation axis of the pressure roller is inclined to each of the pair of sides such that the pair of corners that are positioned front and back in a direction of movement of the moving mechanism are offset in the direction of movement and a distance between the pair of corners is equal to or smaller than a width of the pressure roller.

4. The sheet member bonding apparatus according to claim 1, wherein the sheet support unit includes a pair of sides parallel to the pair of sides of the sheet member, respectively.

5. The sheet member bonding apparatus according to claim 1, wherein the panel support unit includes a pair of sides parallel to a pair of sides of the display panel.

6. The sheet member bonding apparatus according to claim 1, wherein the pressure roller is configured to apply a smaller load on the sheet member when starting and ending bonding of the sheet member to the display panel than middle of the bonding.

7. The sheet member bonding apparatus according to claim 1, wherein the pressure roller is arranged away from the corner of the sheet member frontward of a direction of movement of the panel support unit relative to the sheet support unit and the pressure roller by the moving mechanism when starting bonding of the sheet member to the display panel.

8. The sheet member bonding apparatus according to claim 1, wherein the pressure roller is provided with an elastic material at least on a surface of the pressure roller.

9. A sheet member bonding method comprising:
positioning a sheet member that has at least a pair of sides and a corner formed by the pair of sides and is supported by a sheet support unit opposite a bonding surface of a display panel supported by a panel support unit;
pressing the sheet member against the display panel with a pressure roller, and
moving relatively the panel support unit, the sheet support unit, and the pressure roller with a moving mechanism along the bonding surface while rotating the pressure roller whose rotation axis is inclined to each of the pair of sides of the sheet member.
